(19) United States
(12) Patent Application Publication
(10) Pub. No.: US 2012/0324471 A1
(43) Pub. Date: Dec. 20, 2012

(54) CONTROL DEVICE, MANAGEMENT DEVICE, DATA PROCESSING METHOD OF CONTROL DEVICE, AND PROGRAM

(75) Inventor: Mitsuru Yanagisawa, Tokyo (JP)

(73) Assignee: NEC Corporation, Tokyo (JP)

(21) Appl. No.: 13/581,464

(22) PCT Filed: Feb. 24, 2011
(86) PCT No.: PCT/JP2011/001078

§ 371 Date: Aug. 27, 2012

(30) Foreign Application Priority Data
Feb. 26, 2010 (JP) 2010-041476

(51) Int. Cl. G06F 9/46

(52) U.S. Cl. 718/105

(57) ABSTRACT

A virtual server for measuring performance (100) includes an acquiring unit (52) which acquires respective resource usages of a plurality of resources with respect to a physical server and a virtual server operated on the physical server, a load generating unit (54) which generates a load for a measurement target resource, a dependence number calculating unit (56) which applies the load to the resources to acquire resources on which the measurement target resource depends, and calculate dependence numbers based on the number of resources on which the measurement target resource depends, a ranking unit (58) which ranks the resources in descending order of the calculated dependence numbers, and an adjusting unit (60) which adjusts a processing capability index of the resource usage of the measurement target resource while sequentially selecting one as the measurement target resource from a plurality of resources in the order of the rankings and sequentially applying the load by the load generating unit (54).

### TECHNICAL FIELD

The present invention relates to a control device, a management device, a data processing method of a control device, and a program, and more particularly, to a control device, a management device, a data processing method of a control device, and a program, which estimate a load in order to measure the performance of a virtual server.

### BACKGROUND ART

Patent Document 1 (Japanese Unexamined patent publication NO. 2009-123174) discloses an example of this type of computer system. An object of the computer system is to convert a Central Processing Unit (CPU) load required for Input/Output (I/O) emulation in a virtualization environment from a disk load or a network load and improve the estimation accuracy of the CPU load. FIG. 18 is a block diagram illustrating the structure of the system. Referring to FIG. 18, servers 900, 901, and 902 are non-virtual servers to be integrated. A computer 930 is a terminal having a sizing function. The servers 900, 901, and 902 and the computer 930 are connected to each other by a Local Area Network (LAN) 905.

Each of the servers 900, 901, and 902 is an example of the actual server, and the computer 930 is an example of a virtual machine server sizing device. The servers 900, 901, and 902 include load measuring units 910, 911, and 912, respectively. In addition, the servers 900, 901, and 902 includes, as hardware resources, at least one Central Processing Unit (CPU), and further includes a Hard Disk Drive (HDD), and a Network Interface Card (NIC). The load measuring units 910, 911, and 912 measure the system loads of the servers 900, 901, and 902, respectively, and outputs the measurement result as measurement information. The system load is, for example, a CPU load or a disk or network Input/Output (I/O) load.

The computer 930 includes a performance designing unit 940, a configuration management unit 941, an input device 951 (for example, a keyboard or a mouse), a storage device 952 (for example, an HDD or memory), a processing device 953 (for example, a CPU), and an output device 954 (for example, a display device or a printer). Components in the units and devices will not be described.

The computer system according to the related art having the above-mentioned structure operates as follows. When the CPU load of a server X (not shown) which operates the servers 900, 901, and 902 as virtual servers is estimated, a CPU performance conversion unit 923 obtains the measured values of the CPU loads of the servers 900, 901, and 902. A load conversion unit 920 obtains the estimated value of the CPU load of the server X caused by the disk or network I/O based on the disk load or network load of the servers 900, 901, and 902. A CPU overhead calculating unit 924 obtains a coefficient indicating CPU overhead caused by virtualization. A load estimating unit 925 estimates the CPU load of the server X using the measured value, the estimated value, and the coefficient.

The system is characterized in that CPU overhead corresponding to the I/O is measured when each resource (a disk or a network) is used on the virtual server and the number of times each resource is used by the application on the physical server is measured. The CPU overhead corresponding to the frequency of use of the resources is calculated, the frequency of use of CPU resources is estimated in addition to the CPU overhead, assuming that applications on the physical server are processed on the virtual server, and the frequency of use of the resources is measured when the processing of the applications on the physical server is performed on the virtual server.

Hereinafter, it is assumed that a data center includes physical servers which are provided with various kinds of hardware and software and have different performances. In order to effectively use the resources of the physical server, techniques for supporting resource virtualization (a virtual CPU, a virtual storage, and a virtual network) increase and services, such as Software as a Service (SaaS), is provided on the virtual server. The virtual server constructed on the physical server can be moved between the physical servers and the move destination can use the resources of the physical server. Patent Document 1 discloses a unit for effectively using resources on the physical server.

### RELATED DOCUMENT

### Patent Document

[Patent Document 1] Japanese Unexamined patent publication NO. 2009-123174

### DISCLOSURE OF THE INVENTION

In the above-mentioned computer system, dependence on the resources other than the Central Processing Unit (CPU) is not considered, which makes it difficult to accurately estimate a goal load.

In order to solve the above-mentioned problems, an object of the invention is to provide a control device capable of accurately estimating a load in order to measure the performance of a virtual server, a data processing method of the control device, a program for the control device, and a management device.

According to an aspect of the invention, a control device includes: an acquiring unit which acquires respective resource usages of a plurality of resources with respect to a physical server and a virtual server which is operated on the physical server; a load generating unit which generates a load for a measurement target resource; a dependence number calculating unit which applies the load to the measurement target resource to acquire resources on which the measurement target resource depends, and calculate dependence numbers of the measurement target resource on the basis of the number of resources on which the measurement target resource depends; a ranking unit which ranks a plurality of the resources in descending order of the dependence numbers which is calculated for respective resources as the measurement target resource; and an adjusting unit which adjusts a processing capability index of the resource usage of the measurement target resource while sequentially selecting one as the measurement target resource from a plurality of the resources in the order of the rankings given by the ranking unit and sequentially applying the load to the selected measurement target resource by the load generating unit.

According to another aspect of the invention, a management device includes a presenting unit which presents a processing capability index obtained by the estimating unit in the control device according to the above-mentioned aspect, the control device making the virtual server for measuring performance sequentially operate, as a verification target, on the physical servers which are a plurality of move destination candidates.

According to still another aspect of the invention, there is provided a program that allows a computer to perform: a procedure of acquiring respective resource usages of a plurality of resources with respect to a physical server and a virtual server which is operated on the physical server; a procedure of generating a load for a measurement target resource; a procedure of applying the load to the measurement target resource to acquire resources on which the measurement target resource depends, and calculate dependence numbers of the measurement target resource on the basis of the number of resources on which the measurement target resource depends; a procedure of ranking a plurality of the resources in descending order of the dependence numbers which is calculated for respective resources as the measurement target resource; and a procedure of adjusting a processing capability index of the resource usage of the measurement target resource while sequentially selecting one as the measurement target resource from a plurality of the resources in the order of the rankings and sequentially applying the load to the selected measurement target resource.

According to yet another aspect of the invention, there is provided a data processing method of a control device that measures a load for a plurality of resources with respect to a physical server and a virtual server which is operated on the physical server. The control device acquires respective resource usages of a plurality of the resources with respect to the physical server and the virtual server which is operated on the physical server and generates a load for a measurement target resource, applies the load to the measurement target resource. The control device acquires resources on which the measurement target resource depends, and calculates dependence numbers of the measurement target resource on the basis of the number of resources on which the measurement target resource depends. The control device ranks a plurality of the resources in descending order of the dependence numbers which is calculated for respective resources as the measurement target resource, and adjusts a processing capability index of the resource usage of the measurement target resource while sequentially selecting one as the measurement target resource from a plurality of the resources in the order of the rankings and sequentially applying the load to the selected measurement target resource.

An arbitrary combination of the above-mentioned components and the conversion of the expression of the invention among, for example, a method, an apparatus, a system, a recording medium, and a computer program are also effective as the aspects of the invention.

Various components of the invention are not necessarily independently provided. For example, a plurality of components may be formed as one member, one component may be formed by a plurality of members, a given component may be a portion of another component, and a portion of a given component may overlap a portion of another component.

A plurality of processes is sequentially described in the data processing method and the computer program according to the invention. However, the order of the description does not limit the order in which a plurality of processes is performed. Therefore, when the data processing method and the computer program according to the invention are executed, the order in which a plurality of processes is performed may be changed within the range which does not have an effect on the content of the invention.

In the data processing method and the computer program according to the invention, a plurality of processes is performed at different timings, but the invention is not limited thereto. For example, when a given process is being performed, another process may be generated. In addition, the time when the process is performed may partially or entirely overlap the time when another process is performed.

According to the invention, it is possible to provide a control device, a management device, a data processing method of a control device, and a program capable of accurately estimating a load in order to measure the performance of a virtual server.

### BRIEF DESCRIPTION OF THE DRAWINGS

The above and other objects, advantages, and features of the invention will be more apparent from the following description of certain preferred exemplary embodiments taken in conjunction with the accompanying drawings.

FIG. 1 is a schematic block diagram illustrating the structure of an information processing system according to an exemplary embodiment of the invention.

FIG. 2 is a schematic functional block diagram illustrating the structure of a virtual server for measuring performance according to this exemplary embodiment.

FIG. 3 is a detailed functional block diagram illustrating the structure the virtual server for measuring performance according to this exemplary embodiment.

FIG. 4 is a flowchart illustrating an example of the process procedures of a management server according to this exemplary embodiment in a load adjustment phase.

FIG. 5 is a flowchart illustrating an example of the procedures of a performance measuring process of the virtual server for measuring performance according to this exemplary embodiment when a load is adjusted.

FIG. 6 is a flowchart illustrating an example of the procedures of the performance measuring process of the virtual server for measuring performance according to this exemplary embodiment when a load is adjusted.

FIG. 7 is a flowchart illustrating an example of the process procedures of the management server according to this exemplary embodiment in a load reproduction phase.

FIG. 8 is a flowchart illustrating an example of the procedures of the performance measuring process of the virtual server for measuring performance according to this exemplary embodiment when a load is reproduced.

FIG. 9 is a schematic block diagram illustrating the structure of an information processing system according to an exemplary embodiment of the invention.

FIG. 10 is a functional block diagram illustrating the structure of a virtual server for measuring performance according to this exemplary embodiment.

FIG. 11 is a flowchart illustrating an example of the operation of the virtual server for measuring performance according to this exemplary embodiment.

FIG. 12 is a flowchart illustrating an example of the procedures of a load estimating process in a performance measuring process of the virtual server for measuring performance according to this exemplary embodiment.

FIG. 13 is a diagram illustrating an example of the configuration of set information of the information processing system according to this exemplary embodiment.

FIG. 14 is a diagram illustrating the relationship between a processing capability index and resource usage in an information processing system according to an exemplary embodiment of the invention.

FIG. 15 is a diagram illustrating an example of load information and dependence information in an information processing system according to an exemplary embodiment of the invention.

FIG. 16 is a graph illustrating the dependence relationship according to this exemplary embodiment and is a diagram illustrating resource usage obtained by subtracting a dependent load from a goal load.

FIG. 17 is a graph illustrating the dependence relationship according to this exemplary embodiment and is a diagram illustrating resource usage obtained by subtracting a dependent load from a goal load.

FIG. 18 is a block diagram illustrating the structure of a computer system disclosed in Patent Document.

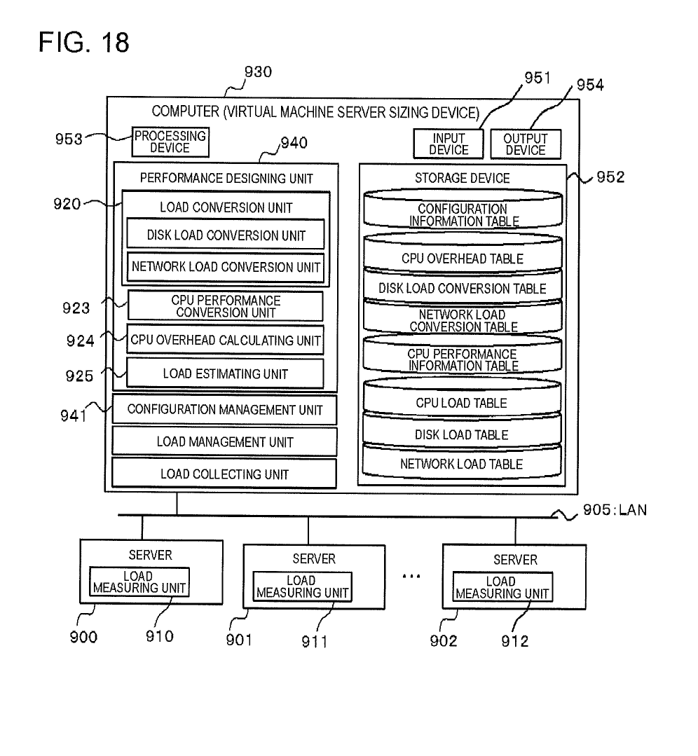

### DESCRIPTION OF EXEMPLARY EMBODIMENTS

### First Exemplary Embodiment

Hereinafter, exemplary embodiments of the invention will be described with reference to the accompanying drawings. In all of the drawings, the same components are denoted by the same reference numerals and the description thereof will not be repeated.

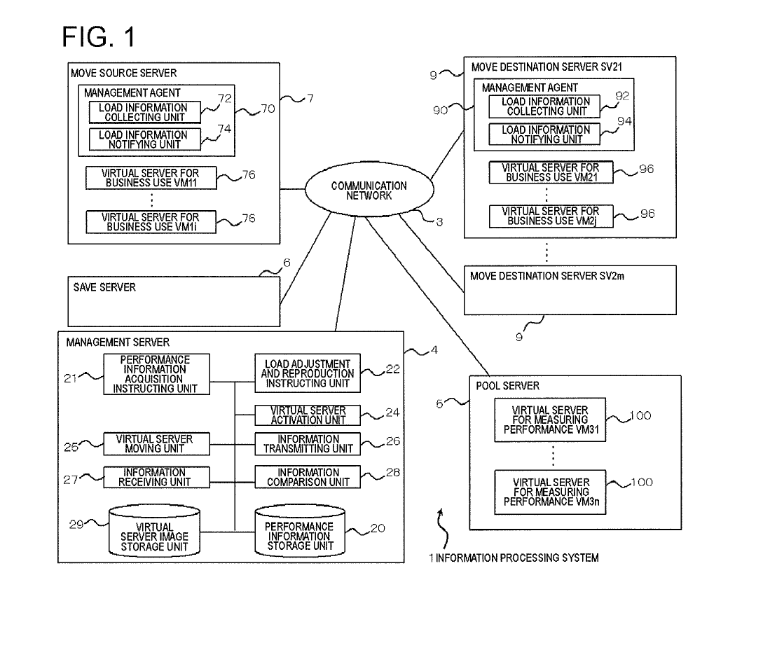

FIG. 1 is a schematic block diagram illustrating the structure of an information processing system 1 according to an exemplary embodiment of the invention.

In the information processing system 1 according to the exemplary embodiment of the invention, a server virtualization technique which divides one physical server computer (hereinafter, referred to as a “physical server”) into a plurality of virtual computers (hereinafter, referred to as “virtual servers”) and operates different Operating Systems (OSs) or applications in the virtual servers is used to effectively use the resources of a plurality of physical servers.

For example, a data center includes a plurality of computers with different performances. The invention relates to a provisioning technique which adjusts the resources using these computers such that a process with the performance corresponding to the user's demand can be performed, thereby providing the optimal services to the user. The virtual server can flexibly distribute the resources according to the user's demand, but the processing performance of the virtual server is reduced by a value corresponding to virtualization overhead.

When a load is generated for a given resource, a load corresponding thereto is generated between other resources. The information processing system 1 according to this exemplary embodiment analyzes the dependence relationship between the resources. Then, the information processing system 1 absorbs the generation of the load due to the characteristics and generates and reaches a goal load. Then, the virtual server which generates a load on the physical server can perform load estimation except for the influence of the overhead between the resources which occurs due to the generation of the load.

The information processing system 1 according to this exemplary embodiment virtualizes resources, such as a plurality of servers or networks, applications, and storages. For example, when there is a demand from the user or when there is a failure, the necessary amount of resources is dynamically allocated to other resources. According to the invention, in this case, before and after the resources are moved, the processing performance of the virtual server can be estimated in advance as accurately as possible, thereby preventing a large variation in the load when the load is moved or from getting a high load. In addition, according to the invention, the system has the performances meeting the user's needs.

The invention can be applied to a data center business that effectively operates the virtual servers which are provided in a monitoring middleware product and are operated on the physical server.

As shown in FIG. 1, the information processing system 1 according to this exemplary embodiment includes a management server 4, a pool server 5, a save server 6, a move source server 7 including a management agent 70, and a plurality of move destination servers 9 (SV21, . . . , SV2m; m is a natural number) each having a management agent 90. These servers are connected to each other through a communication network 3. The communication network 3 is not particularly limited, but is configured such that the servers can communicate with each other. For example, the communication network 3 may be a Local Area Network (LAN), a Wide Area Network (WAN), a mobile communication network, a fixed telephone communication network, the Internet, and combinations thereof.

Each of the pool server 5, the move source server 7, the move destination server 9, and the save server 6 is a physical server in which a virtual server can be provided and which has a function for movement between the servers. Each physical server includes, for example, a CPU, memory, a hard disk, and a communication device which are not shown in the drawings and can be implemented by a server computer or a personal computer which is connected to an input device, such as a keyboard or a mouse, or an output device, such as a display or a printer, or equivalents thereto. The CPU can read the program stored in the hard disk to the memory and execute the program, thereby implementing each function of each unit. In the following drawings, the configuration of portions which are not related to the essence of the invention is not described and shown.

Each component of the information processing system 1 is implemented by an arbitrary combination of hardware and software including a CPU and memory of an arbitrary computer, a program which is loaded to the memory and implements the components shown in the drawings, a storage unit, such as a hard disk storing the program, and an interface for connection to the network. It will be understood by those skilled in the art that the implementation method and apparatus can be modified in various ways. Each of the following drawings shows blocks in a function unit, not in a hardware unit.

In this exemplary embodiment, there are two types of virtual servers. One of the two types of virtual servers is virtual servers for business use 76 (VM11, . . . , VM1i; i is a natural number) and virtual servers for business use 96 (VM21, . . . , VM2j in the case of move destination servers SV21; j is a natural number) for business, and the other type of virtual server is virtual servers for measuring performance 100 (VM31, . . . , VM3n; n is a natural number) which perform a performance measuring process according to the invention. In this exemplary embodiment, at least one move source server 7 is provided, but the invention is not limited thereto. In some cases, the move destination server 9 is not provided. For example, when the performance measuring process according to this exemplary embodiment is performed, the move destination server 9 is not provided in order to introduce a new move destination server.

It is assumed that the virtual server for business use 76 and the virtual server for business use 96 include applications for executing, for example, Web, mail, and backup and process them. The virtual server for measuring performance 100 according to this exemplary embodiment is operated on the pool server 5. Like the virtual servers for measuring performance 100 (VM31 to VM3n) shown in FIG. 1, a plurality of (n) virtual servers may be operated on the pool server 5.

The management agent 70 of the move source server 7 includes a load information collecting unit 72 and a load information notifying unit 74 and instructs the start or end of the functions. The virtual server for business use 76 is operated on the move source server 7. A plurality of (i) virtual servers for business use 76 (in FIG. 1, VM11 to VM1i) may be operated on the move source server 7. The load information collecting unit 72 collects the resource usage of the move source server 7 and the virtual servers operated on the move source server 7. The load information notifying unit 74 periodically transmits the resource usage collected by the load information collecting unit 72 to the management server 4 through the communication network 3.

The management agent 90 of the move destination server 9 includes a load information collecting unit 92 and a load information notifying unit 94 and instructs the start or end of the functions. The virtual server for business use 96 is operated on the move destination server 9. A plurality of virtual servers for business use 96 (j virtual servers for business use on a move destination server SV21 and x, y, z, . . . virtual servers for business use on the other move destination servers SV2m (m is 2, 3, 4, . . . )) may be operated on each move destination server 9 (in FIG. 1, virtual servers VM21 to VM2j are operated on the move destination server SV21 and the virtual servers on the other move destination server SV2m are not shown). The load information collecting unit 92 collects the resource usage of the move destination server 9 and the virtual servers operated on the move destination server 9. The load information notifying unit 94 periodically transmits the resource usage collected by the load information collecting unit 92 to the management server 4 through the communication network 3.

When the performance measuring process according to the invention, which will be described below, is performed, the save server 6 is a physical server which temporarily saves the virtual server for business use 76 operated on the move source server 7. In this way, the information processing system 1 according to this exemplary embodiment can perform the performance measuring process according to the invention, without stopping the actual business services. It is assumed that there is a sufficient amount of resources in the save server 6 such that the resources are not insufficient even when the virtual server for business use 76 is saved.

The management server 4 includes a performance information acquisition instructing unit 21, a load adjustment and reproduction instructing unit 22, a virtual server activation unit 24, a virtual server moving unit 25, an information transmitting unit 26, an information receiving unit 27, an information comparison unit 28, a virtual server image storage unit 29, and a performance information storage unit 20.

The information processing system 1 according to this exemplary embodiment includes a load adjustment phase and a load reproduction phase. First, in the load adjustment phase, the information processing system 1 according to this exemplary embodiment generates a load on the move source server 7 in a pseudo manner and performs performance measurement. Then, in the load reproduction phase, the information processing system 1 according to this exemplary embodiment generates a load on the move destination server 9 on the basis of a processing capability index obtained in the load adjustment phase and acquires resource usage.

The performance information storage unit 20 stores the processing capability index of each resource which is received from the virtual server for measuring performance 100 operated on the move source server 7 in the load adjustment phase. In addition, in the load reproduction phase, the performance information storage unit 20 stores the resource usage of the move destination server 9 which is received from the virtual server for measuring performance 100 operated on the move destination server 9, for example, in time series.

The performance information acquisition instructing unit 21 instructs the load adjustment and reproduction instructing unit 22 to adjust or reproduce the load. In this exemplary embodiment, the operator may use, for example, an operation unit (not shown) to input a load adjustment instruction or a load reproduction instruction to the management server 4 of the information processing system 1. The performance information acquisition instructing unit 21 instructs the load adjustment and reproduction instructing unit 22 in response to the instruction. In this case, the performance information acquisition instructing unit 21 receives information indicating the move source server 7 to be measured from the operator.

In addition, the operator may create a load adjustment or load reproduction schedule and register the schedule in the management server 4 in advance and the performance information acquisition instructing unit 21 may automatically output the instruction according to the schedule. In this case, it is possible to perform verification in the night when the system is not actually operated. In this way, even when a failure occurs, it is possible to minimize damage.

In the load adjustment phase, the load adjustment and reproduction instructing unit 22 moves the virtual server for measuring performance 100 to the move source server 7 in order to operate the virtual server for measuring performance 100 on the pool server 5, instead of the virtual server for business use 76 operated on the move source server 7 which is designated to be a measurement target. Then, the load adjustment and reproduction instructing unit 22 instructs the virtual server moving unit 25 to move the virtual server for business use 76 operated on the move source server 7 to the save server 6. In addition, the load adjustment and reproduction instructing unit 22 instructs the virtual server moving unit 25 to move the virtual server for business use 76 to the original position when the process ends.

The load adjustment and reproduction instructing unit 22 transmits a performance information measurement instruction to the virtual server for measuring performance 100 moved to the move source server 7 through the communication network 3 using the information transmitting unit 26.

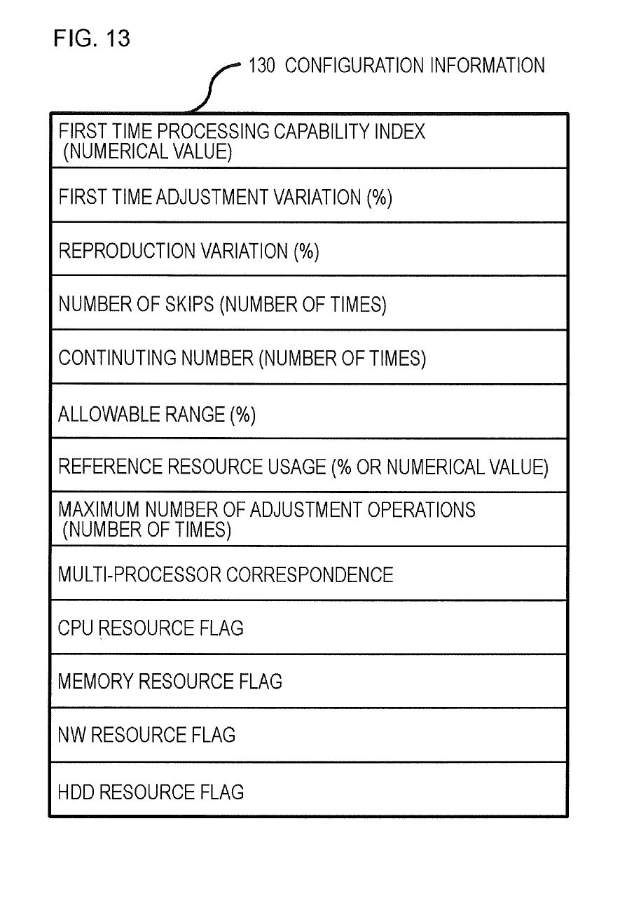

The performance information measurement instruction includes set information 130 shown in FIG. 13 and information about the amount of each resource of the virtual server for measuring performance 100. The set information 130 can be set by the operator. The set information 130 may receive parameters which are set by the operation unit from, for example, a setting screen or it may be received in a set file format.

As shown in FIG. 13, the set information 130 includes information for each virtual server. For example, the set information 130 includes a first processing capability index (numerical value), a first adjustment variation (%), a reproduction variation (%), the number of skips (number of times), the number of continuations (number of times), an allowable range (%), reference resource usage (% or a numerical value), the maximum number of adjustment operations (number of times), multi-processor correspondence, a CPU resource flag, a memory resource flag, an NW (network) resource flag, and an HDD resource flag.

The first processing capability index (numerical value) is set for each resource. When a performance measurement program is used first to generate a load, the first processing capability index is used. The first adjustment variation (%) may be set for each resource and is the range of a load variation when the performance measurement program is used first to generate a load.

The reproduction variation (%) may be set for each resource and is the range of a load variation when the performance measurement program is used to generate a load during the reproduction of the load. The number of skips (number of times) may be set for each resource and is the number of times the resource load information received from the physical server is skipped, considering the case in which the amount of load is not increased completely. The number of continuations (number of times) may be set for each resource. When a load corresponding to the reference processing capability index is output and measured, the number of continuations is the number of times the measurement result is within the allowable range.

The allowable range (%) may be set for each resource. When the load corresponding to the reference processing capability index is output and measured, the allowable range is a range from reference resource usage.

The reference resource usage (% or a numerical value) may be set for each resource and is a reference value at a sufficiently small load not to affect other virtual servers. The maximum number of adjustment operations (number of times) may be set for each resource and is for obtaining the reference resource usage.

The multi-processor correspondence indicates the maximum number of CPU cores in a measurement server environment when there are multiple processors.

The CPU resource flag, the memory resource flag, the NW resource flag, and the HDD resource flag indicate whether to measure CPU resources, memory resources, NW resources, and HDD resources. In the CPU and memory resources, the CPU resource flag and the memory resource flag indicate whether to perform measurement. In the NW and HDD resources, the NW resource flag and the HDD resource flag indicate an input or an output, or both the input and the output.

The setting of the flags is used in a process which will be described below.

Returning to FIG. 1, in the load reproduction phase, the load adjustment and reproduction instructing unit 22 instructs the virtual server moving unit 25 to move the virtual server for measuring performance 100 on the pool server 5 onto the move source server 7 which is designated to be a measurement target.

Then, the load adjustment and reproduction instructing unit 22 transmits a load reproduction instruction to the virtual server for measuring performance 100 through the communication network 3 using the information transmitting unit 26. The load reproduction instruction includes the processing capability index of the virtual server for business use 76 on the move source server 7 which is estimated by the virtual server for measuring performance 100 in the load adjustment phase, which will be described below.

The virtual server image storage unit 29 stores the images of the virtual servers operated in the information processing system 1. The virtual server activation unit 24 copies the image of each of the virtual servers which are registered in the virtual server image storage unit 29 to the start server such that the virtual servers startup. For example, like the virtual servers for measuring performance 100 (VM31 to VM31n) for measuring the performance shown in FIG. 1, a plurality of virtual servers may start up.

As described above, the virtual server moving unit 25 moves each virtual server in response to the instruction from the load adjustment and reproduction instructing unit 22.

The information transmitting unit 26 transmits instructions or information to the virtual server for measuring performance 100 operated on the move source server 7 or the virtual server for measuring performance 100 operated on the move destination server 9 through the communication network 3.

The information receiving unit 27 receives information from the virtual server for measuring performance 100 operated on the move source server 7 or the virtual server for measuring performance 100 operated on the move destination server 9 through the communication network 3.

The information comparison unit 28 acquires the resource usage of the move destination server 9 stored in the performance information storage unit 20 in the load reproduction phase. Then, when a plurality of move destination servers 9 (SV21 to SV2m) use resources, the information comparison unit 28 presents the amounts of resources used on, for example, a display unit (not shown) such that the amounts of resources used can be compared with each other.

In this exemplary embodiment, the management server 4 sequentially operates the virtual server for measuring performance 100 on the physical servers (move destination servers 9), which are a plurality of move destination candidates. The management server 4 may include a presenting unit (not shown) that presents the processing capability index obtained by an estimating unit (load adjusting unit 111) as a physical server to be verified.

The functions of each unit of the management server 4 are implemented by the execution of a computer program by the computer. The computer program may be recorded on a computer-readable recording medium. The recording medium is not particularly limited, but various recording media may be considered. The program may be loaded from the recording medium to the memory of the computer, or it may be downloaded to the computer through the network and then loaded to the memory.

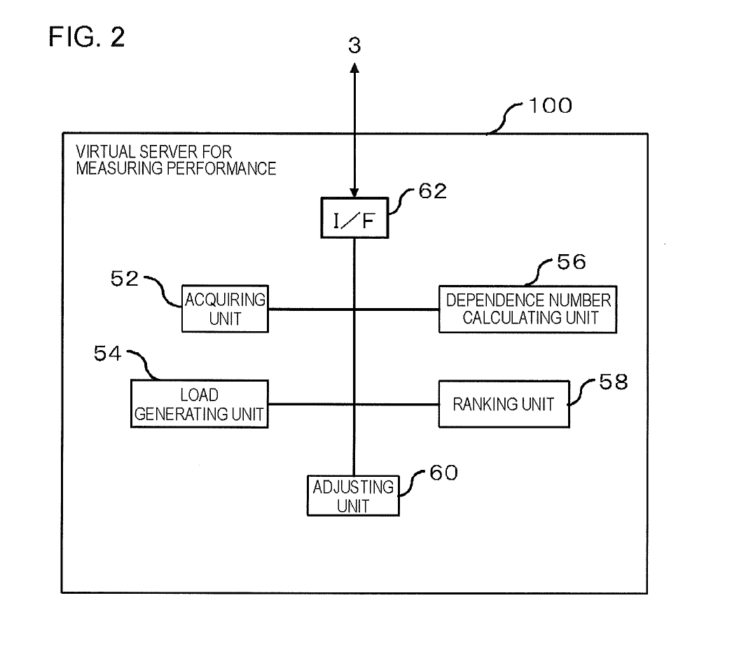

FIG. 2 is a functional block diagram illustrating the structure of the virtual server for measuring performance 100 according to this exemplary embodiment.

A control device (virtual server for measuring performance 100) according to this exemplary embodiment includes an acquiring unit 52 that acquires respective resource usages of a plurality of resources (not shown) with respect to a physical server (the move source server 7 or the move destination server 9) and a virtual server (the virtual server for business use 76 or the virtual server for business use 96) operated on the physical server, a load generating unit 54 that generates a load for a measurement target resource, a dependence number calculating unit 56 that applies the load to the measurement target resource to acquire resources on which the measurement target resource depends, and calculate dependence numbers of the measurement target resource on the basis of the number of resources on which the measurement target resource depends, a ranking unit 58 that ranks a plurality of the resources in descending order of the dependence numbers which is calculated for respective resources as the measurement target resource, and an adjusting unit 60 that adjusts the processing capability index of the resource usage of the measurement target resource while sequentially selecting one as the measurement target resource from a plurality of the resources in the order of the rankings given by the ranking unit 58 and sequentially applying the load to the selected measurement target resource by the load generating unit 54.

In addition, the virtual server for measuring performance 100 includes an interface (represented by “I/F” in FIG. 2) 62. The interface 62 is connected to the management server 4, the save server 6, the move source server 7, and the move destination server 9 through the communication network 3 and communicates with them. The control device is the virtual server for measuring performance 100 which can be operated on the physical server. The physical server on which the virtual server for measuring performance 100 will be operated is determined by an instruction from the management server 4. That is, the control device according to the invention may be implemented by any computer since the physical server on which the virtual server for measuring performance 100 will be operated is not determined.

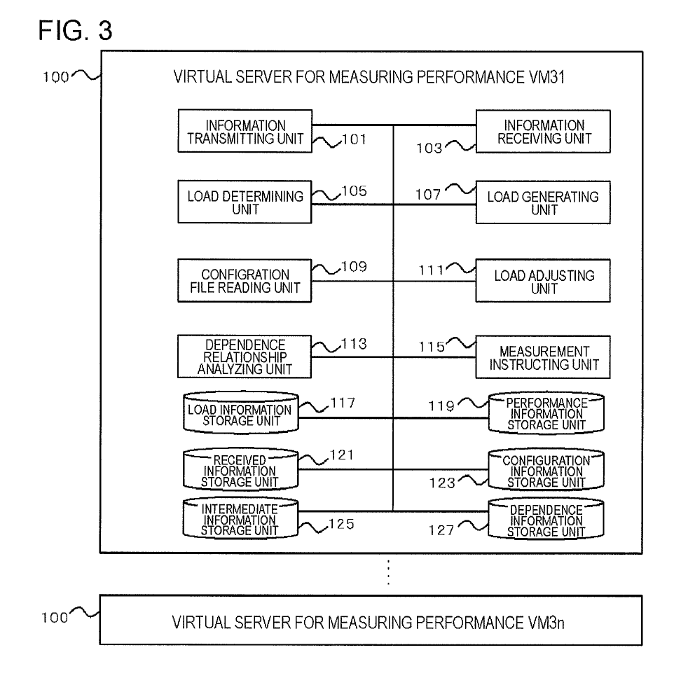

Specifically, as shown in FIG. 3, the virtual server for measuring performance 100 according to this exemplary embodiment includes an information transmitting unit 101, an information receiving unit 103, a load determining unit 105, a load generating unit 107, a configuration file reading unit 109, a load adjusting unit 111, a dependence relationship analyzing unit 113, a measurement instructing unit 115, a load information storage unit 117, a performance information storage unit 119, a received information storage unit 121, a configuration information storage unit 123, an intermediate information storage unit 125, and a dependence information storage unit 127. In FIG. 3, the virtual server for measuring performance VM31 is shown. However, the structure of the measuring virtual server VM31 is the same as that of the other virtual servers for measuring performance VM3n.

The control device (virtual server for measuring performance 100) according to this exemplary embodiment further includes a detecting unit (load determining unit 105) that detects whether the resource usage of any resource other than the measurement target resource is increased or decreased on the basis of the resource usage which is acquired by the information receiving unit 103 while the load is applied by the load generating unit 107 and a determining unit (load determining unit 105) that determines that the measurement target resource depends on the resources other than the measurement target resource when the increase or decrease of the resource usage of some resource other than the measurement target resource is detected. The dependence number calculating unit (dependence relationship analyzing unit 113) counts the number of resources which are determined to depend on the measurement target resource by the load determining unit 105 and calculates the dependence numbers.

The control device (virtual server for measuring performance 100) according to this exemplary embodiment operates the virtual server for measuring performance 100 for implementing each unit of the control device on the move source server 7 (FIG. 1), which is a move source, instead of least one virtual server (in FIG. 1, the virtual server for business use 76) operated on the physical server (in FIG. 1, the move source server 7). The load generating unit 107 generates a load on the move source server 7, instead of at least one virtual server for business use 76 operated on the move source server 7. The information receiving unit 103 periodically acquires the respective resource usages of a plurality of resources with respect to the move source server 7 and the virtual server for measuring performance 100 operated on the move source server 7. The load adjusting unit 111 adjusts the processing capability index.

In the control device (virtual server for measuring performance 100) according to this exemplary embodiment, the load adjusting unit 111 adjusts the processing capability index on the basis of the resource usage of each resource which is acquired by the information receiving unit 103 such that resource usage obtained by subtracting the resource usage of the measurement target resource to which the load is currently applied by the load generating unit 107 corresponding to the resource usage of the resources which are other than the current measurement target resource and to which the load has been previously applied by the load generating unit 107, from a predetermined target resource usage of the virtual server, is acquired. The control device (virtual server for measuring performance 100) includes: a determining unit (load determining unit 105) that determines whether the absolute value of the target resource usage is within an allowable range from the resource usage acquired by the information receiving unit 103 while the load generating unit 107 sequentially selects one as the measurement target resource from a plurality of the resources in the order of the rankings given by the dependence relationship analyzing unit 113 on the basis of the processing capability index adjusted by the load adjusting unit 111 and sequentially generates the load; and an estimating unit (load adjusting unit 111) that estimates the processing capability index corresponding to the target resource usage from the resource usage acquired by the information receiving unit 103 when the load determining unit 105 determines that it is within the allowable range.

Specifically, in the load adjustment phase, the information transmitting unit 101 transmits information about the processing capability index obtained by the performance measuring process to the management server 4 through the communication network 3. In addition, in the load reproduction phase, the information transmitting unit 101 transmits information about the latest resource usage to the management server 4 through the communication network 3.

The information receiving unit 103 receives instructions or information from the management server 4, the move source server 7, or the move destination server 9 through the communication network 3 and stores the received instructions or information in a predetermined storage unit. For example, the information receiving unit 103 receives a performance information measurement instruction from the load adjustment and reproduction instructing unit 22 of the management server 4 and stores the performance information measurement instruction in the received information storage unit 121. The information receiving unit 103 periodically receives the resource usage from the load information notifying unit 74 of the move source server 7 which generates a load in a pseudo manner and stores the resource usage in the load information storage unit 117. In addition, the information receiving unit 103 receives a load reproduction instruction from the load adjustment and reproduction instructing unit 22 and stores the load reproduction instruction in the received information storage unit 121. The information receiving unit 103 periodically receives the resource usage from the load information notifying unit 94 on the move destination server 9 which reproduces the load and stores the resource usage in the load information storage unit 117. The information receiving unit 103 corresponds to the acquiring unit 52 shown in FIG. 2.

The received information storage unit 121 stores the instructions or information received by the information receiving unit 103 from the management server 4, the move source server 7, or the move destination server 9 through the communication network 3.

The load information storage unit 117 stores the resource usages of respective resources which are periodically received by the information receiving unit 103 from the load information notifying unit 74 of the move source server 7 in the load adjustment phase. In addition, the load information storage unit 117 stores the resource usages of respective resources which are periodically received by the information receiving unit 103 from the load information notifying unit 94 of the move destination server 9 in the load reproduction phase.

The load determining unit 105 determines the dependence relationship between the resources on the basis of the resources usage of the move source server 7 or the move destination server 9 with reference to the load information storage unit 117 in the load adjustment phase. In addition, the load determining unit 105 calculates the dependence numbers of each resource as the measurement target resource on the basis of the number of resources on which the measurement target resource depends. The load determining unit 105 corresponds to the dependence number calculating unit 56 shown in FIG. 2. The calculated dependence numbers is stored for each resource in the dependence information storage unit 127.

The load determining unit 105 detects whether the resource usage of any resource other than the measurement target resource is increased or decreased. When it is detected that the resource usage of some resource is increased or decreased, the load determining unit 105 determines that the measurement target resource depends on the resources. In this exemplary embodiment, the load determining unit 105 determines the dependence relationship on the basis of an increase or decrease in the resource usage acquired by the load information collecting unit of the management agent provided in each server, but the invention is not limited thereto. For example, the dependence relationship may be determined by other monitoring tools using an index indicating an increase or decrease in the resource usage of the server.

In addition, the load determining unit 105 reads the final resource usage on the basis of the resource usage of the move destination server 9 with reference to the load information storage unit 117 in the load reproduction phase. The load determining unit 105 transmits the read final resource usage to the management server 4 through the communication network 3 using the information transmitting unit 101.

The configuration file reading unit 109 reads each parameter from the set information 130 shown in FIG. 13 which has been received from the management server 4 and then stored in the received information storage unit 121 and stores the parameters in the configuration information storage unit 123.

The configuration information storage unit 123 stores the parameters of the set information 130 which are read from the received information storage unit 121 by the configuration file reading unit 109.

The load adjusting unit 111 adjusts the processing capability index in the load adjustment phase according to a procedure, which will be described below. The processing capability index is adjusted on the basis of the processing capability index for each resource updated after the load is generated and the resource usage of each resource which is periodically measured such that the resource usage of the virtual server for business use 76 is obtained. The load adjusting unit 111 corresponds to the adjusting unit 60 shown in FIG. 2.

The performance information storage unit 119 stores the processing capability index adjusted by the load adjusting unit 111 for each resource.

The measurement instructing unit 115 instructs the load generating unit 107 to generate a load for the resources in a resource unit. A method of applying the load will be described in detail below.

The load generating unit 107 generates a load for the measurement target resource of the virtual server for measuring performance 100 on the move source server 7 or the virtual server for measuring performance 100 on the move destination server 9 in a pseudo manner. The load generating unit 107 corresponds to the load generating unit 54 shown in FIG. 2.

The dependence relationship analyzing unit 113 ranks the resources in the order of the dependence (in descending order) on the basis of the measurement result of the performance for each resource in the dependence information storage unit 127. The dependence relationship analyzing unit 113 corresponds to the ranking unit 58 shown in FIG. 2.

The intermediate information storage unit 125 stores the resource usage of some resource other than the measurement target resource in the load adjustment phase.

The dependence information storage unit 127 stores the dependence numbers of each resource calculated by the load determining unit 105.

The functions of each unit of the virtual server for measuring performance 100 are implemented by the execution of the computer program by the computer.

The computer program according to this exemplary embodiment allows the computer for implementing the virtual server for measuring performance 100 to perform: a procedure of acquiring respective resource usages with respect to a plurality of resources with respect to a physical server (the move source server 7 in FIG. 1) and the virtual server (the virtual server for business use 76 in FIG. 1) operated on the move source server 7 (FIG. 1), a procedure of generating a load for a measurement target resource in a pseudo manner; a procedure of applying the load to the measurement target resource to acquire resources on which the measurement target resource depends, and calculate dependence numbers of the measurement target resource on the basis of the number of resources on which the measurement target resource depends; a procedure of ranking the resources in descending order of the dependence numbers which is calculated for respective resources as the measurement target resource; and a procedure of adjusting the processing capability index of the resource usage of the measurement target resource while sequentially selecting one as the measurement target resource from a plurality of the resources in the order of the rankings and sequentially applying the load to the selected measurement target resource. Hereinafter, the program is referred to as a performance measurement program.

The performance measurement program according to this exemplary embodiment allows the computer to further perform: a procedure of operating the virtual server for measuring performance 100 including the program on the move source server 7 (FIG. 1), which is a move source, instead of at least one virtual server (the virtual server for business use 76 in FIG. 1) operated on the physical server (the move source server 7 in FIG. 1); a procedure of generating a load on the move source server 7 (FIG. 1), which is the move source, instead of at least one virtual server for business use 76 operated on the move source server 7; a procedure of periodically acquiring the respective resource usages of a plurality of resources with respect to the move source server 7 and the virtual server for measuring performance 100 operated on the move source server 7; and a procedure of adjusting the processing capability index.

The performance measurement program according to this exemplary embodiment allows the computer to further perform: a procedure of adjusting the processing capability index on the basis of the resource usage of each resource acquired in the acquiring procedure such that resource usage obtained by subtracting the resource usage of the measurement target resource to which the load is currently applied in the load generation procedure corresponding to the resource usage of the resources which are other than the current measurement target resource and to which the load has been previously applied in the load generation procedure, from a predetermined target usage of the measurement target resource of the virtual server, is acquired; a procedure of determining whether the absolute value of the target resource usage is within the allowable range from the resource usage acquired in the acquiring procedure while the load generation procedure selects one as the measurement target resource from a plurality of the resources in the order of the rankings given in the ranking procedure on the basis of the processing capability index adjusted in the adjusting procedure and sequentially generates the load; and a procedure of estimating the processing capability index corresponding to the target resource usage from the resource usage acquired in the acquiring procedure when it is determined in the determining procedure that it is within the allowable range.

The computer program according to this exemplary embodiment may be recorded on a computer-readable storage medium. The recording medium is not particularly limited, but various recording media may be considered. The program may be loaded from the recording medium to the memory of the computer, or it may be downloaded to the computer through the network and then loaded to the memory.

Next, the operation of the information processing system 1 according to this exemplary embodiment having the above-mentioned structure will be described.

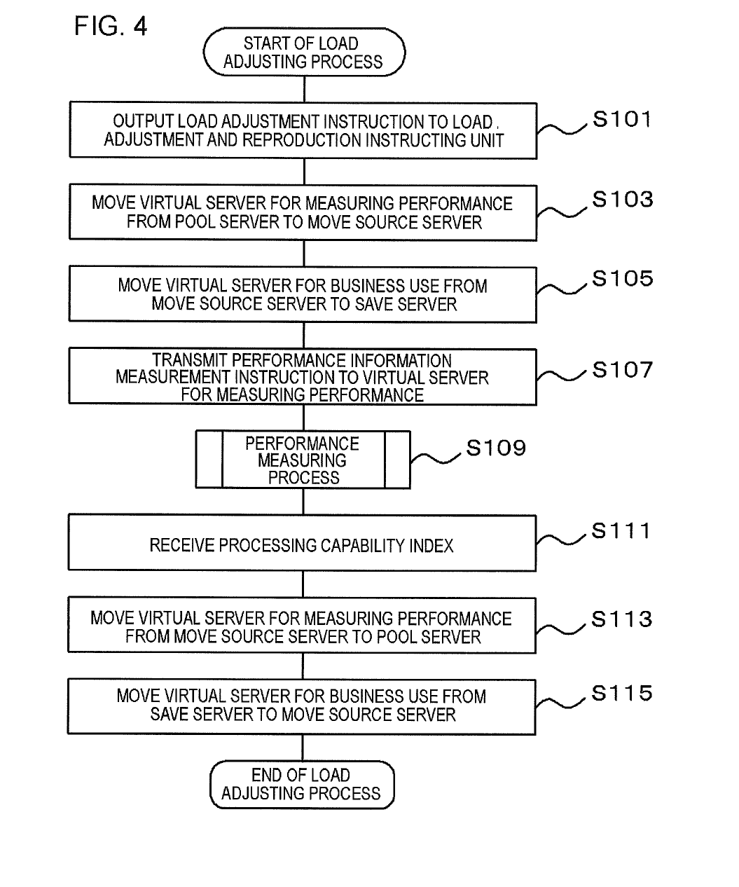

FIGS. 4 to 8 are flowcharts illustrating an example of the operation of the information processing system 1 according to this exemplary embodiment.

As described above, the information processing system 1 according to this exemplary embodiment includes the load adjustment phase and the load reproduction phase. First, in the load adjustment phase, the information processing system 1 according to this exemplary embodiment generates a load on the move source server 7 in a pseudo manner and measures the performance. Then, in the load reproduction phase, the information processing system 1 according to this exemplary embodiment generates a load on the move destination server 9 on the basis of the processing capability index obtained in the load adjustment phase and acquires resources usage.

In the information processing system 1 according to this exemplary embodiment, first, the management server 4 starts the load adjustment phase. In the load adjustment phase, the virtual server for measuring performance 100 applies the load corresponding to the virtual server for business use 76 to the move source server 7 and measures the performance. Then, the management server 4 starts the load reproduction phase, generates a load onto the move destination server 9, and acquires resources usage.

First, in the management server 4, it is assumed that the images of two types of virtual servers, that is, the virtual server for measuring performance 100 and the virtual servers for business use 76 and 96 are registered in the virtual server image storage unit 29.

In this exemplary embodiment, it is assumed that the virtual server activation unit 24 starts the virtual server for measuring performance 100 on the pool server 5 in advance. As the start method, a method may be used which instructs the virtual server activation unit 24 to copy the image of the virtual server for measuring performance 100 registered in the virtual server image storage unit 29 to the pool server 5 and to start the virtual server for measuring performance 100 for performance measurement. Like the virtual servers for measuring performance 100 (VM31 to VM31n) for performance measurement, a plurality of virtual servers may start up.

In addition, the virtual server activation unit 24 starts up the virtual servers for business use 76 (VM11 to VM1i) and the virtual servers for business use 96 (VM21 to VM2j) on the move source server 7 and the move destination servers 9 (SV21 to SV2m), respectively. As the start method, a method may be used which instructs the virtual server activation unit 24 to copy the images of the virtual servers for business use registered in the virtual server image storage unit 29 onto the move source server 7 and the move destination servers 9 (SV21 to SV2m) and to start the virtual servers for business use 76 (VM11 to VM1i) and the virtual servers for business use 96 (VM21 to VM2j). Like the virtual servers for business use 76 (VM11 to VM1i) and the virtual servers for business use 96 (VM21 to VM2j, VM81 to VM8x, VM91 to VM9y, . . . ), a plurality of virtual servers may start up.

The virtual servers for business use 76 (VM11 to VM1i), the virtual servers for business use 96 (VM21 to VM2j), and the virtual servers for measuring performance 100 (VM31 to VM3n) generate loads using a client process or a job scheduling process. It is assumed that the loads consume the resources of the physical server (the move source server 7, the move destination server 9, or the pool server 5).

In this state, when the operator inputs a load adjustment instruction or a load reproduction instruction using the operation unit (not shown), the performance information acquisition instructing unit 21 receives the instruction.

In the following description, for simplicity, for example, it is assumed that one virtual server for measuring performance 100 and one virtual server for business use 76 are provided.

### <Load Adjustment Phase>

FIG. 4 is a flowchart illustrating an example of the process procedure of the load adjustment phase in the management server 4 according to this exemplary embodiment. Next, the procedure will be described with reference to FIGS. 1 and 4.

First, when the performance information acquisition instructing unit 21 (FIG. 1) receives the load adjustment instruction from the operator, the management server 4 (FIG. 1) instructs the load adjustment and reproduction instructing unit 22 (FIG. 1) to adjust the load (Step S101 in FIG. 4). Then, in response to the load adjustment instruction, the load adjustment and reproduction instructing unit 22 (FIG. 1) instructs the virtual server moving unit 25 (FIG. 1) to move the virtual server for measuring performance 100 (FIG. 1) on the pool server 5 (FIG. 1) onto the move source server 7 (FIG. 1) designated by the operator. The adjustment process is not performed on the physical server (move source server 7) which is not designated by the operator. In response to the instruction, the virtual server for measuring performance 100 (FIG. 1) is moved from the pool server 5 (FIG. 1) to the move source server 7 (FIG. 1) (Step S103 in FIG. 4).

The virtual server moving unit 25 (FIG. 1) has already been implemented by the existing technique including an operation management product and a virtualization middleware product. In this exemplary embodiment, a method of implementing the virtual server moving unit 25 is not particularly limited. Then, the load adjustment and reproduction instructing unit 22 (FIG. 1) instructs the virtual server moving unit 25 (FIG. 1) to move the virtual server for business use 76 (FIG. 1) on the move source server 7 (FIG. 1) onto the save server 6 (FIG. 1). In response to the instruction, the virtual server for business use 76 (FIG. 1) on the move source server 7 (FIG. 1) is moved to the save server 6 (FIG. 1) (Step S105 in FIG. 4).

Then, the load adjustment and reproduction instructing unit 22 (FIG. 1) transmits a performance information measurement instruction to the virtual server for measuring performance 100 (FIG. 1) through the communication network 3 (FIG. 1) using the information transmitting unit 26 (FIG. 1) (Step S107 in FIG. 4). The performance information measurement instruction includes the amount of each resource of the virtual server for business use 76 (FIG. 1) and the set information 130 shown in FIG. 13.

The virtual server for measuring performance 100 (FIG. 1) starts a performance measuring process in response to the performance information measurement instruction (Step S109 in FIG. 4). The performance measuring process of the virtual server for measuring performance 100 (FIG. 1) will be described in detail below.

When the performance measuring process of the virtual server for measuring performance 100 (FIG. 1) ends, the information receiving unit 27 (FIG. 1) in the management server 4 receives from the processing capability index from each virtual server for measuring performance 100 (FIG. 1) on the move source server 7 (FIG. 1) and stores the processing capability index in the performance information storage unit 20 (FIG. 1) (Step S111 in FIG. 4).

The load adjustment and reproduction instructing unit 22 (FIG. 1) instructs the virtual server moving unit 25 (FIG. 1) to move the virtual server for measuring performance 100 (FIG. 1) on the move source server 7 (FIG. 1) onto the pool server 5 (FIG. 1). In response to the instruction, the virtual server for measuring performance 100 (FIG. 1) on the move source server 7 (FIG. 1) is moved onto the pool server 5 (FIG. 1) (Step S113 in FIG. 4).

In addition, the load adjustment and reproduction instructing unit 22 (FIG. 1) instructs the virtual server moving unit 25 (FIG. 1) to move the virtual server for business use 76 (FIG. 1) on the save server 6 (FIG. 1) onto the move source server 7 (FIG. 1). In response to the instruction, the virtual server for business use 76 (FIG. 1) on the save server 6 (FIG. 1) is moved onto the move source server 7 (FIG. 1) (Step S115 in FIG. 4). In this way, the load adjustment phase ends, and the performance measuring process is performed without stopping the actual business services.

Next, the data processing method of the virtual server for measuring performance 100 according to this exemplary embodiment will be described.

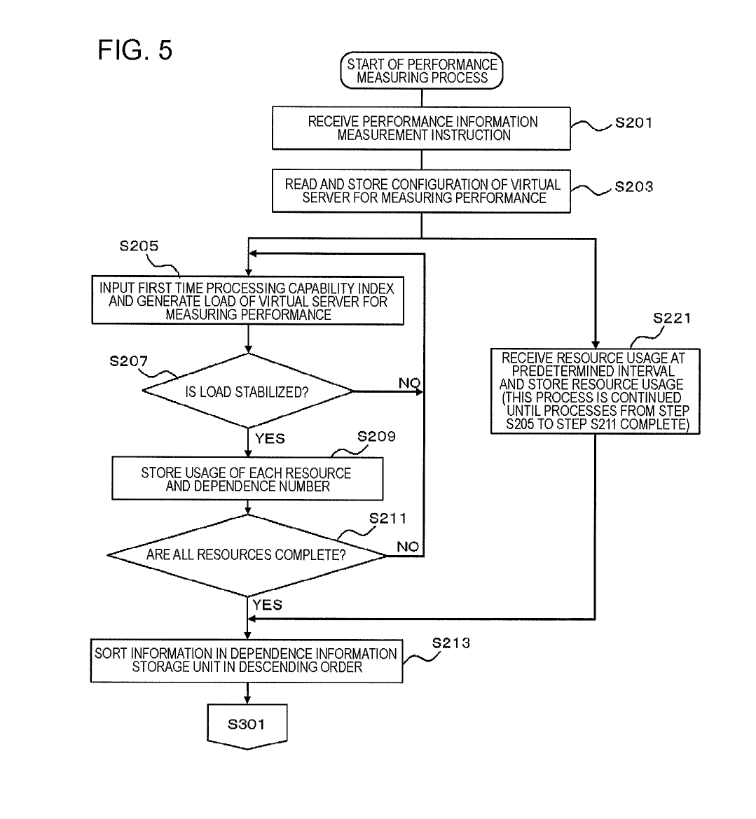

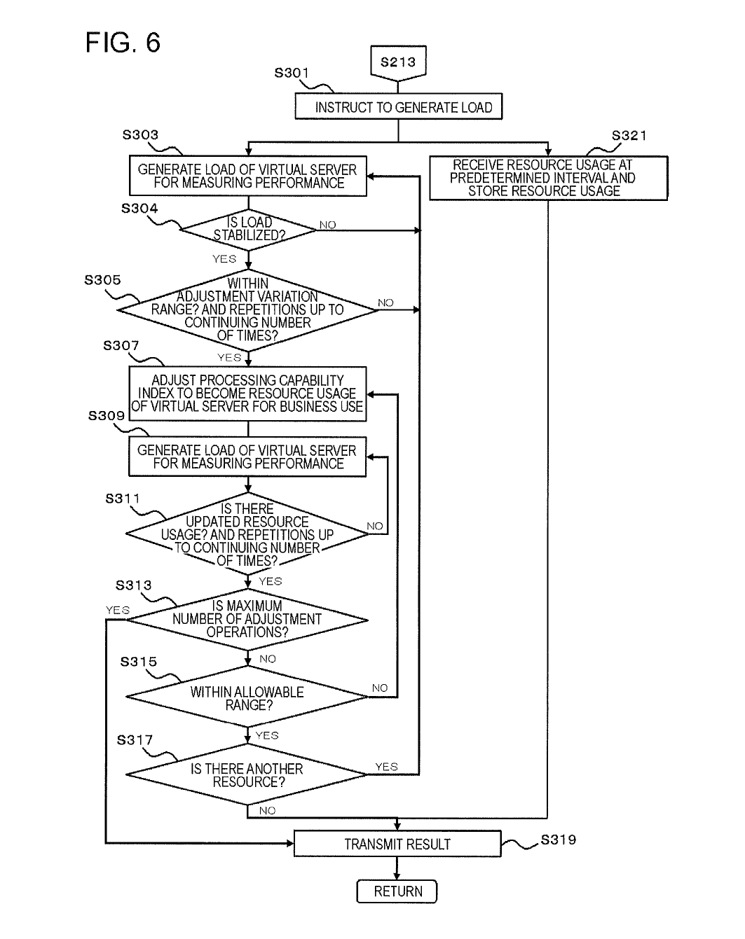

FIGS. 5 and 6 are flowcharts illustrating an example of the performance measuring process of the virtual server for measuring performance 100 according to this exemplary embodiment when the load is adjusted. As described above, the performance measurement program according to this exemplary embodiment allows the computer to perform the following processes, thereby implementing the functions of the virtual server for measuring performance 100 according to this exemplary embodiment. This flow is called from Step S109 of the load adjustment process in the load adjustment phase of the management server 4 according to this exemplary embodiment shown in FIG. 4. Next, the flow will be described with reference to FIG. 1, FIGS. 3 to 6, and FIG. 13.

A data processing method of the virtual server for measuring performance 100 according to this exemplary embodiment is a data processing method of a control device (virtual server for measuring performance 100) that measures a load for a plurality of resources with respect to a physical server (move source server 7) and a virtual server (virtual server for business use 76) operated on the move source server 7. In the data processing method, the control device (virtual server for measuring performance 100) acquires respective resource usages of a plurality of resources with respect to the move source server 7 and the virtual server operated on the move source server 7 (Step S221 in FIG. 5). The control device generates a load for a measurement target resource (Step S205 in FIG. 5). The control device applies the load to the measurement target resource to acquire resources on which the measurement target resource depends, and calculate dependence numbers of the measurement target resource on the basis of the number of resources on which the measurement target resource depends (Step S209 in FIG. 5). The control device ranks a plurality of the resources in descending order of the dependence numbers which is calculated for respective resources as the measurement target resource (Step S213 in FIG. 5). The control device adjusts the processing capability index of the resource usage of the measurement target resource (Step S307 in FIG. 6) while sequentially selecting one as the measurement target resource from a plurality of the resources in the order of the rankings and sequentially generating the load to the selected measurement target resource (Step S303 in FIG. 6).

In addition, in the data processing method of the virtual server for measuring performance 100, the virtual server for measuring performance 100 is operated on the move source server 7, which is a move source, instead of at least one virtual server operated on the move source server 7, thereby implementing the control device (Step S103 in FIG. 4). The virtual server for measuring performance 100 generates the load on the move source server 7, instead of at least one virtual server for business use 76 operated on the move source server 7, which is the move source (Step S303 in FIG. 6). The resource usage of a plurality of resources with respect to the move source server 7 and the virtual server for measuring performance 100 operated on the move source server 7 is periodically acquired (Step S321 in FIG. 6). The processing capability index is adjusted (Step S307 in FIG. 6).

In the data processing method of the virtual server for measuring performance 100, the virtual server for measuring performance 100 adjusts the processing capability index on the basis of the acquired usage of each resource such that resource usage obtained by subtracting the resource usage of the measurement target resource to which the load is currently applied corresponding to the resource usage of the resources which are other than the current measurement target resource and to which the load has been previously applied, from a predetermined target resource usage of the virtual server, is acquired (Step S307 in FIG. 6). The virtual server for measuring performance 100 determines whether the absolute value of the target resource usage from the acquired resource usage is within the allowable range (Steps S313 and S315 in FIG. 6) while selecting one as the measurement target resource from a plurality of the resources in the order of the rankings on the basis of the adjusted processing capability index and sequentially generating the load (Step S309 in FIG. 6). When it is determined that it is within the allowable range (YES of Step S315 in FIG. 6), the virtual server for measuring performance 100 estimates the processing capability index corresponding to the target resource usage from the acquired resource usage (Step S319 in FIG. 6).

Specifically, first, in the virtual server for measuring performance 100 (FIG. 3), the information receiving unit 103 (FIG. 3) receives the performance information measurement instruction transmitted from the management server 4 (FIG. 1) in Step S107 of FIG. 4 and stores the performance information measurement instruction in the received information storage unit 121 (FIG. 3) (Step S201 in FIG. 5). Then, in response to the performance information measurement instruction, the measurement instructing unit 115 (FIG. 3) instructs the configuration file reading unit 109 (FIG. 3) to read the parameters of the set information 130 shown in FIG. 13. In response to the instruction, the configuration file reading unit 109 (FIG. 3) reads the set parameters of the virtual server for measuring performance 100 designated by the set information 130 (FIG. 13) from the received information storage unit 121 and stores the set parameters in the configuration information storage unit 123 (FIG. 3) (Step S203 in FIG. 5).

Next, a dependence relationship analysis process of the virtual server for measuring performance 100 (FIG. 3) starts.

As shown in FIG. 5, the measurement instructing unit 115 (FIG. 3) instructs the load generating unit 107 (FIG. 3) to generate a load for each resource. In response to the instruction, the load generating unit 107 (FIG. 3) processes a job with the resources designated to be measured, using the first processing capability index designated by the set information 130 (FIG. 13) as an input, with reference to each resource flag of the set information 130 (FIG. 13), thereby generating a load for each resource (Step S205 in FIG. 5). No process is performed on the resources which are not measured.

In Step S205 of FIG. 5, the load generating unit 107 may start processes corresponding to the number of cores from multi-processor information, like the set information 130 shown in FIG. 13, and a plurality of processes may generate loads at the same time. That is, the load generating unit 107 may perform a plurality of load generation processes or threads and the estimating unit (load adjusting unit 111) may estimate the processing capability index of the virtual server in a multi-processor environment.

In the case of multiple processors, when the performance measuring program is executed for CPU resources, one process is allocated to one CPU. Therefore, when measurement is performed on two CPUs, a maximum of 50% of CPU resources is used in each server (the move source server 7 or the move destination server 9). When there is a server with multiple CPUs in the environment of the server (the move source server 7 in the load adjustment phase and the move destination server 9 in the load reproduction phase), which is a measurement target, this process is considered to use CPU resources as much as possible. As a result, regardless of whether there is a single CPU or there are multiple CPUs, it is possible to perform comparison with the processing capability index.

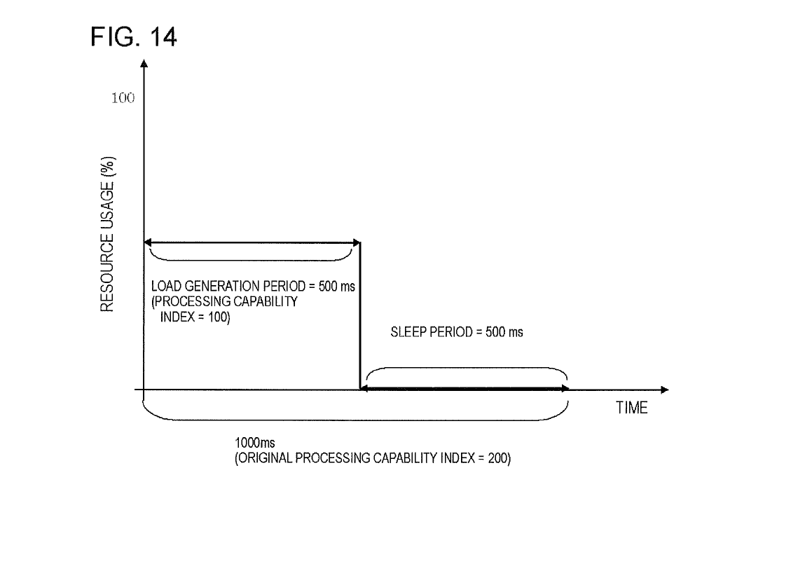

The job is the unit of work performed by an information processing apparatus whose representative example is a server and the size of the job is defined as the processing capability index. For example, in the case of the CPU, the number of numerical operations may be defined as the size of the job, and the load may be adjusted on the basis of the size of the job. As shown in FIG. 14, the generation of the load and the stopping (sleep) of the generation of the load are repeatedly performed within a predetermined period to adjust the resource usage output from the physical server. This is an illustrative example, but the method of generating a goal load is not limited thereto.

As shown in FIG. 14, in a case in which the original processing capability index of the server is 200, when the processing capability index is set to 100, the resource usage is 50%. In this case, a load generation period and a sleep period are 500 ms and are alternately repeated. When the processing capability index is changed to 50, the resource usage is 25%. In this case, the load generation period is 250 ms and the sleep period is 750 ms. The load generation period and the sleep period are alternately repeated.

In this exemplary embodiment, the resources correspond to the CPU, the memory, the NW, and the HDD and are calculated as resource usage or a usage rate. The usage rate is known from the resource usage of the physical server and the virtual server within a predetermined period. For example, the NW alternately performs an NW input and output process per second and the sleep process for a predetermined period to control the load which is generated at the same time as the load is generated in the CPU. The HDD alternately performs a reading and writing process per second and the sleep process for a predetermined period to control the load which is generated at the same time as the load is generated in the CPU. In this exemplary embodiment, the HDD may be shared by the servers through the network. The resources are not limited to the above, but other dependent resources may be measured.

As another example, the load generation period and the sleep period may be repeated in a shorter cycle. For example, the load generation period and the sleep period may be repeated in a cycle of 100 ms.

Returning to FIG. 5, in parallel to Steps S205 to S211, the information receiving unit 103 (FIG. 3) periodically receives the resource usage of each resource from the load information notifying unit 74 (FIG. 1) of the management agent 70 (FIG. 1) of the move source server 7 (FIG. 1) through the communication network 3 (FIG. 1) and stores the resource usage in the load information storage unit 117 (FIG. 3). In the move source server 7 (FIG. 1), it is assumed that the load information collecting unit 72 (FIG. 1) of the management agent 70 (FIG. 1) periodically transmits the acquired resource usage of the move source server 7 (FIG. 1) and the virtual server for measuring performance 100 (FIG. 1) to the information receiving unit 103 (FIG. 3) of the management server 4 (FIG. 3) through the communication network 3 (FIG. 1) (Step S221 in FIG. 5).

For example, as described above, since the load generation period and the sleep period are alternately repeated in a cycle of 1000 ms, the resource usage may be monitored at an interval of 1000 ms. When the interval at which the resource usage is monitored is shorter than the load generation period, the acquired resource usage is likely to be incorrect. Therefore, the interval at which the resource usage is monitored may be equal to or more than a load generation cycle, which is the sum of the load generation period and the sleep period.

Then, the load determining unit 105 (FIG. 3) determines whether the load of the measurement target resource is stabilized (Step S207 in FIG. 5). For example, first, the load determining unit 105 (FIG. 3) checks whether the resource usage of the measurement target resource (periodically updated in Step S221 of FIG. 5) in the load information storage unit 117 (FIG. 3) is updated. When any one is not updated, the process returns to Step S205 in FIG. 5. When there is the updated resource usage and the skip operation reaches the number of skip operations set in the set information 130 shown in FIG. 13, it is determined that the load is stabilized (YES in Step S207 of FIG. 5) and the load determining unit 105 (FIG. 3) uses the updated resource usage. When the skip operation does not reach the number of skip operations, it is determined that the load has not been stabilized (NO in Step S207 of FIG. 5) and the process returns to Step S205 in FIG. 5.

Immediately after the load is applied, the server is not stabilized and the influence of the load is not directly reflected to the resource usage. Therefore, the skip operation is performed a predetermined number of times to stabilize the server. In this way, it is possible to obtain an accurate value. The resource usage may be periodically monitored to check whether the load is stabilized. However, the method of performing the skip operation a predetermined number of times is better than the periodical monitoring method since it is simple and has a small processing load.

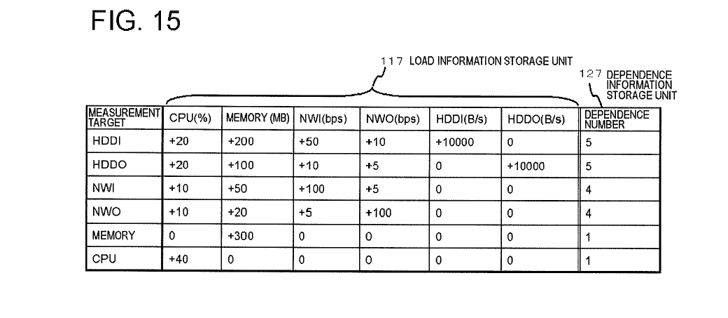

Then, when it is checked that the resource usage of the measurement target resource stored in the load information storage unit 117 (FIG. 3) is updated and it is determined that some resource usage of other resources is more than that before the load is generated, the load determining unit 105 (FIG. 3) determines that the dependence relationship is established. Then, the load determining unit 105 stores the dependence numbers of each resource in the dependence information storage unit 127 (FIG. 3) shown in FIG. 15, using the count value of the increased resources as the dependence numbers (Step S209 in FIG. 5). FIG. 15 shows the usage of each resource stored in the load information storage unit 117 (FIG. 3) and the dependence numbers corresponding thereto. The resource usage of each resource may be stored so as to be associated with the dependence numbers.

When the load adjusting unit 111 (FIG. 3) stops the measurement of the target and there are other measurement target resources which have not been measured (NO in Step S211 of FIG. 5), the process returns to Step S205 in FIG. 5 and Steps S205 to S209 are repeatedly performed using another resource as a measurement target. When there is no remaining resource (YES in Step S211 of FIG. 5), the process proceeds to the next Step S213 in FIG. 5. In this case, the reception of the resource usage in Step S221 of FIG. 5 is stopped and the process proceeds to Step S213 in FIG. 5.

Then, the dependence relationship analyzing unit 113 sorts the measurement results of the resources in the dependence information storage unit 127 in the order (descending order) of the dependence numbers on the resources (Step S213 in FIG. 5).

In this way, the dependence relationship analysis process ends and the dependence relationship for each resource is calculated as shown in FIG. 15.

Next, the virtual server for measuring performance 100 starts a load estimating process on the basis of the dependence relationship obtained by the dependence relationship analysis process. Next, the load estimating process will be described with reference to FIGS. 1, 3, and 6.

First, the measurement instructing unit 115 (FIG. 3) instructs the load generating unit 107 (FIG. 3) to apply a load in the order (descending order) of the value of the dependence numbers stored in the dependence information storage unit 127 (FIG. 3) (Step S301 in FIG. 6). The reason is as follows. In the structure in which the load is applied to the resources in descending order of the dependence numbers, when the load is applied to another resource with the small dependence numbers, it is possible to generate a goal load while absorbing the previous dependent load. When the load is applied to the resources in ascending order of the dependence numbers, the load will be more than the goal load later.

Then, the load generating unit 107 (FIG. 3) generates a load for the resources to be measured, with reference to each resource flag of the set information 130 shown in FIG. 13 (Step S303 in FIG. 6). In the first operation, a resource load is generated on the basis of the first processing capability index set in the set information 130. In the second and subsequent operations, the resource load is generated on the basis of the processing capability index updated by the process, which will be described below. No process is performed on the resources which are not measured. In this exemplary embodiment, when the processing capability index is input to the load generating unit 107, the load of the virtual server for measuring performance 100 is generated.

In Step S303 of FIG. 6, the load generating unit 107 starts processes corresponding to the number of cores from multi-processor information, like the set information 130 shown in FIG. 13, and a plurality of processes can generate loads at the same time. That is, the load generating unit 107 performs a plurality of load generation processes or threads. Then, the estimating unit (load adjusting unit 111) can estimate the processing capability index of the virtual server in a multi-processor environment.

In the case of multiple processors, when the performance measuring program is executed for CPU resources, one process is allocated to one CPU. Therefore, when measurement is performed on two CPUs, a maximum of 50% of CPU resources is used in each server (the move source server 7 or the move destination server 9). When there is a server with multiple CPUs in the environment of the server (the move source server 7 in the load adjustment phase and the move destination server 9 in the load reproduction phase), which is a measurement target, this process is considered to use CPU resources as much as possible. As a result, regardless of whether there is a single CPU or there are multiple CPUs, it is possible to perform comparison with the processing capability index.

In parallel to Steps S303 to S317, the information receiving unit 103 (FIG. 3) periodically receives the resource usage of each resource from the load information notifying unit 74 (FIG. 1) of the management agent 70 (FIG. 1) of the move source server 7 (FIG. 1) through the communication network 3 (FIG. 1) and stores the resource usage in the load information storage unit 117 (FIG. 3). In the move source server 7 (FIG. 1), it is assumed that the load information collecting unit 72 (FIG. 1) of the management agent 70 (FIG. 1) periodically transmits the acquired resource usage of the move source server 7 (FIG. 1) and the virtual server for measuring performance 100 (FIG. 1) operated on the move source server 7 to the information receiving unit 103 (FIG. 3) of the virtual server for measuring performance 100 (FIG. 3) through the communication network 3 (FIG. 1) (Step S321 in FIG. 6).

Then, the load determining unit 105 (FIG. 3) determines whether the load of the measurement target resource is stabilized (Step S304 in FIG. 6). For example, first, the load determining unit 105 (FIG. 3) checks whether the resource usage of the measurement target resource (periodically updated in Step S321 of FIG. 6) in the load information storage unit 117 (FIG. 3) is updated. When any one is not updated, the process returns to Step S303 in FIG. 6. When there is some updated resource usage and the number of skip operations reaches a predetermined value set in the set information 130 shown in FIG. 13, it is determined that the load is stabilized (YES in Step S304 of FIG. 6) and the load determining unit 105 (FIG. 3) adopts the updated resource usage. When the number of skip operations does not reach the predetermined value, it is determined that the load has not been stabilized (NO in Step S304 of FIG. 6), and the process returns to Step S303 in FIG. 6.

The load determining unit 105 (FIG. 3) determines whether a fluctuation in the resource load is within the variation range. For example, the load determining unit 105 (FIG. 3) compares the latest resource usage and the previous resource usage of the virtual server for measuring performance 100 and determines whether the difference therebetween is within the first adjustment variation range of the set information 130 shown in FIG. 13. When the difference is within the range, the load determining unit determines whether measurement is continuously performed a predetermined number of times stored in the set information 130 shown in FIG. 13 (Step S305 in FIG. 6). When the conditions are not satisfied (NO in Step S305 of FIG. 6), the process returns to Step S303 in FIG. 6.

When the conditions are satisfied (YES in Step S305 of FIG. 6), the load adjusting unit 111 (FIG. 3) is based on the first processing capability index of the set information 130 shown in FIG. 13 in the first operation and associates the updated processing capability index with the resource usage of the virtual server for measuring performance 100 in the second or subsequent operations. The load adjusting unit 111 estimates the processing capability index for generating a load corresponding to resource usage which is obtained by subtracting the resource usage of the measurement target resource from the resource usage of each resource received from the management server 4 (FIG. 1), with reference to the resource usage of the measurement target data of the intermediate information storage unit 125 (FIG. 3), and stores the processing capability index in the performance information storage unit 119 (FIG. 3). The following Mathematical Expression (1) is used to estimate the processing capability index. When the resource usage of the measurement target data is not stored in the intermediate information storage unit 125 (FIG. 3), dependent resource usage in the intermediate information storage unit 125 (FIG. 3) is not used.

Mathematical Expression (1) defines a numerical expression used in the load adjustment phase or the load reproduction phase of this exemplary embodiment.

The processing capability index (NUM_TAR) of the virtual server for business use 76 (or the virtual server for business use 96) is defined from the current processing capability index (NUM_BSE) and resource usage (P_AVM) of the virtual server for measuring performance 100, the resource usage (P_TAR) of the virtual server for business use 76 (or the virtual server for business use 96), and the dependent resource usage (P_DEP) of each measurement target by the following Mathematical Expression (1).

NUM_{—}TAR=NUM_{—}BSE×((P_{—}TAR−ΣP_{—}DEP)/P_{—}AVM) Math. (1)

For example, the dependent resource usage (P_DEP) of each measurement target corresponds to the amount of resources. When HDDI (input of HDD resources) shown in FIG. 15 is measured, the resource usage of some resource other than HDDI corresponds to the dependent resource usage. This value is added for each measurement operation.

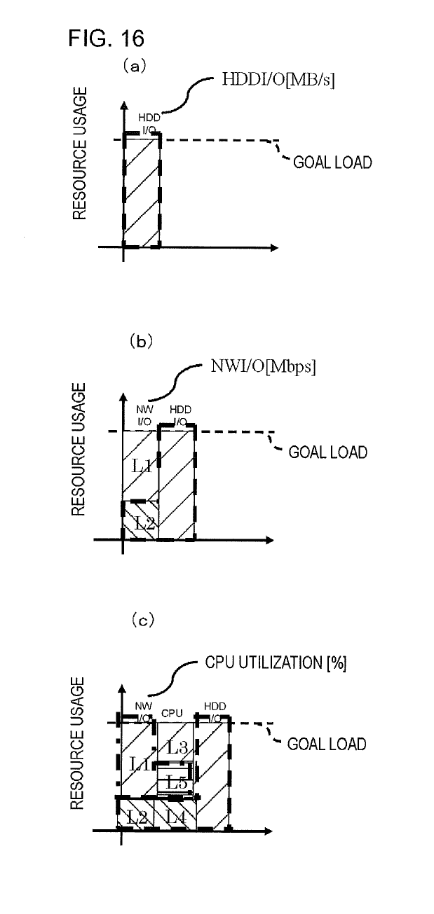

FIG. 16 shows an example of a method of estimating each resource load from the dependence characteristics of the load which is sorted in descending order of the dependence numbers shown in FIG. 15 (HDDI/O (input and output of HDD resources)>NWI/O (input and output of NW)>CPU=memory). A goal load is the resource usage of the virtual server for business use 76 (or the virtual server for business use 96). As shown in FIG. 16(a), when the load of HDDI/O is generated, particularly, there is no dependence relationship. The generated processing capability index is used.

Next, as shown in FIG. 16(b), when the load of NWI/O is estimated, the load (L2) of NWI/O is generated together with the load of HDDI/O. Therefore, the resource usage of a load (L1) obtained by subtracting the load (L2) from a goal load estimates the processing capability index which can be output. As described above, in this exemplary embodiment, the HDD can be shared by the servers through the network. Therefore, when a load is generated for HDDI/O, a load is also generated for NWI/O. In FIG. 16, the load generated by HDDI/O is a portion surrounded by a bold dashed line.

When NWI/O_T is target NWI/O (NWI/O generated by the virtual server) usage (L1+L2) and NWI/O_HDDI/O is NWI/O usage (L2) generated by HDDI/O, NWI/O_E, which is actually estimated NWI/O usage (L1), is represented by the following Mathematical Expression (2).

NWI/O_{—}E=NWI/O_{—}T−(NWI/O_{—}HDDI/O) Math. (2)

When the load of the CPU is estimated as shown in FIG. 16 (c), a CPU load (L4) is generated at the time when the load of HDDI/O and a CPU load (L5) is generated at the time when the load of NWI/O is generated. Therefore, the resource usage of a load (L3) obtained by subtracting the loads (L4) and (L5) from a goal load estimates the processing capability index which can be output. In FIG. 16(c), the load generated by NWI/O is a portion surrounded by a bold dashed line.

When CPU_T is target CPU usage (CPU usage generated by the virtual server) (L3+L4+L5), CPU_NWI/O is CPU usage (L5) generated by NWI/O, and CPU_HDDI/O is CPU usage (L4) generated by HDDI/O, CPU_E, which is actually estimated CPU usage (L3), is represented by the following Mathematical Expression (3).

CPU_{—}E=CPU_{—}T−(CPU_{—}NWI/O+CPU_{—}HDDI/O) Math. (3)

In this way, it is possible to estimate the processing capability index for target resource usage (Step S307 in FIG. 6). That is, the load generating unit 107 (FIG. 3) adjusts the processing capability index on the basis of the updated processing capability index and resource usage such that the resource usage of the virtual server for business use 76 (or the virtual server for business use 96) is obtained.

The load generating unit 107 (FIG. 3) performs a process on the basis of the estimated processing capability indexes of the resources, thereby generating the load of the resources of the virtual server for measuring performance 100 (FIG. 1) (Step S309 in FIG. 6). In this case, when the processing capability index is input to the load generating unit 107, the load of the virtual server for measuring performance 100 is generated.

When it is checked that the resource usage of the load information storage unit 117 (FIG. 3) is updated and measurement is continuously performed a predetermined number of times set in the set information 130 shown in FIG. 13 (YES in Step S311 of FIG. 6), the load determining unit 105 (FIG. 3) adopts the resource usage. When there is no updated resource usage in the load information storage unit 117 or when the number of continuations does not reach the predetermined value (NO in Step S311 of FIG. 6), the process returns to Step S309 in FIG. 6.

The load determining unit 105 (FIG. 3) determines whether the number of times the processing capability index is adjusted to obtain reference resource usage, that is, the maximum number of adjustment operations set in the set information 130 shown in FIG. 13 is satisfied (Step S313 in FIG. 6). When the maximum number of adjustment operations is satisfied (YES in Step S313 of FIG. 6), the determination result including the content of an error is transmitted to the management server 4 through the communication network 3 (FIG. 1), and the process returns to Step S111 in FIG. 4 (Step S319 in FIG. 6).

When the determination result in Step S313 of FIG. 6 is NO, the load determining unit 105 (FIG. 3) performs conversion to the resource usage of the virtual server for measuring performance 100 obtained from the processing capability index and an execution process corresponding to the processing capability index. Then, the load determining unit 105 determines whether the resource usage is within the allowable range of the reference resource usage set in the set information 130 shown in FIG. 13 (Step S315 in FIG. 6). When the conditions are satisfied (YES in Step S315 of FIG. 6), the process proceeds to the next Step S317 in FIG. 6. When the conditions are not satisfied (NO in Step S315 of FIG. 6), the process returns to Step S307 in FIG. 6.

When the determination result in Step S315 of FIG. 6 is NO, the load adjusting unit 111 (FIG. 3) stores the processing capability index of the measurement target in the performance information storage unit 119 (FIG. 3) and stores the resource usage of some resource other than the measurement target at that time in the intermediate information storage unit 125 (FIG. 3). When there are other measurement target resources whose load has not been generated (YES in Step S317 of FIG. 6), the process returns to Step S303 in FIG. 6 and the subsequent process is performed on other measurement target resources while the load of the target resource is generated. When there is no measurement target resource whose load has not been generated (NO in Step S317 of FIG. 6), the process proceeds to the next Step S319 in FIG. 6. In this case, the reception of the resource usage in Step S321 of FIG. 6 is also stopped and the process proceeds to Step S319 in FIG. 6.

That is, when the generation of the load for all of the target resources ends (NO in Step S317 of FIG. 6), the information transmitting unit 101 (FIG. 3) transmits the processing capability index stored in the performance information storage unit 119 (FIG. 3) as the result to the management server 4 (FIG. 1) through the communication network 3 (Step S319 in FIG. 6).

In this way, the load estimating process of the virtual server for measuring performance 100 ends and the process returns to Step S111 in FIG. 4.

### <Load Reproduction Phase>

Next, the load reproduction phase will be described.

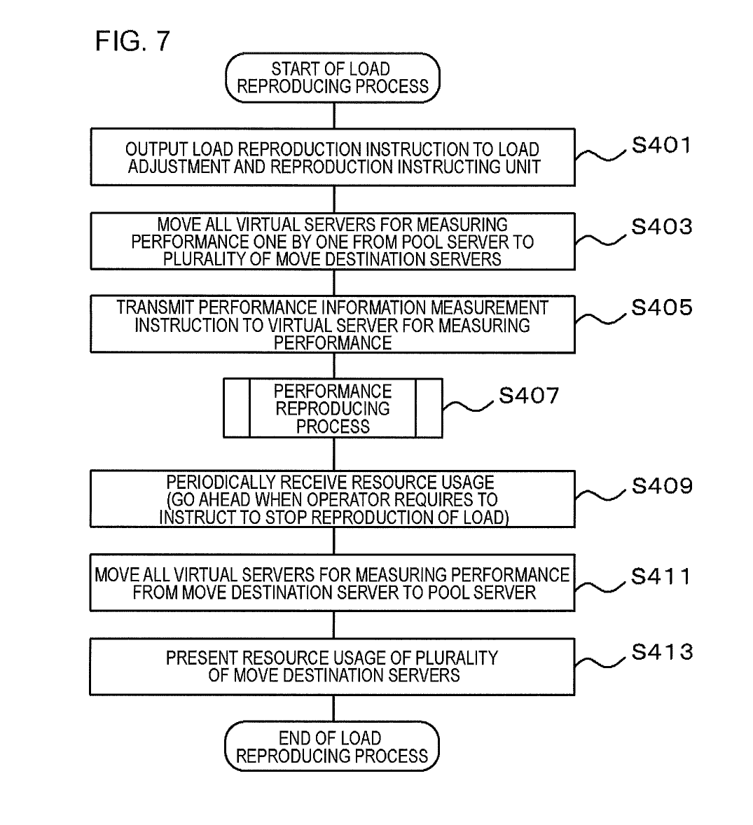

FIG. 7 is a flowchart illustrating an example of the process of the management server 4 according to this exemplary embodiment in the load reproduction phase. Hereinafter, the process will be described with reference to FIGS. 1 and 7.

First, in the management server 4 (FIG. 1), when receiving a load reproduction instruction from the operator, the performance information acquisition instructing unit 21 (FIG. 1) instructs the load adjustment and reproduction instructing unit 22 (FIG. 1) to reproduce the load (Step S401 in FIG. 7). At that time, in addition to the load reproduction instruction, an instruction to designate the move destination server 9 is received. In response to the load reproduction instruction, the load adjustment and reproduction instructing unit 22 (FIG. 1) instructs the virtual server moving unit 25 (FIG. 1) to move the virtual server for measuring performance 100 (FIG. 1) on the pool server 5 (FIG. 1) onto each move destination server 9 (FIG. 1) which is designated by the user. The reproducing process is not performed on the move destination server 9 (FIG. 1) which is not designated. In response to the instruction, the virtual servers for measuring performance 100 (FIG. 1) are moved one by one from the pool server 5 (FIG. 1) to the move destination servers 9 (FIG. 1) (Step S403 in FIG. 7).

Then, the load adjustment and reproduction instructing unit 22 (FIG. 1) transmits a performance information measurement instruction to the virtual server for measuring performance 100 (FIG. 1) through the communication network 3 (FIG. 1) using the information transmitting unit 26 (FIG. 1) (Step S405 in FIG. 7). The performance information measurement instruction includes the processing capability index of the virtual server for business use 76 (FIG. 1) on the move source server 7 (FIG. 1) which is estimated by the virtual server for measuring performance 100 (FIG. 1).

Then, the virtual server for measuring performance 100 (FIG. 1) reproduces the load and performs a performance measuring process on the basis of the reproduced load, in response to the performance information measurement instruction (Step S407 in FIG. 7). The performance measuring process of the virtual server for measuring performance 100 (FIG. 1) will be described in detail below.

When the performance measuring process of the virtual server for measuring performance 100 (FIG. 1) ends, the management server 4 (FIG. 1) receives resource usage from the virtual server for measuring performance 100 (FIG. 1) on the move destination server 9 (FIG. 1) using the information receiving unit 27 (FIG. 1) and stores the resource usage in the performance information storage unit 20 (FIG. 1) (Step S409 in FIG. 7). This receiving process is periodically repeated. When an instruction is received from the operator, the load reproducing process is stopped and the process proceeds to the next Step S411 in FIG. 7.

Then, the load adjustment and reproduction instructing unit 22 (FIG. 1) instructs the virtual server moving unit (FIG. 1) to move the virtual server for measuring performance 100 (FIG. 1) on the move destination server 9 (FIG. 1) onto the pool server 5 (FIG. 1). In response to the instruction, the virtual server for measuring performance 100 on the move destination server 9 is moved onto the pool server 5 (Step S411 in FIG. 7).

The information comparison unit 28 (FIG. 1) acquires the amount of resources used by the move destination server 9 (FIG. 1) which is stored in the performance information storage unit 20 (FIG. 1). Then, when the process is performed on a plurality of move destination servers 9 (SV21 to SV2m) (FIG. 1), the information comparison unit 28 presents the amounts of resources used on, for example, the display unit (not shown) such that they can be compared with each other (Step S413 in FIG. 7). In this way, the operator can determine the movement of the virtual server to the physical server (move destination server 9) to which a large load is not applied.

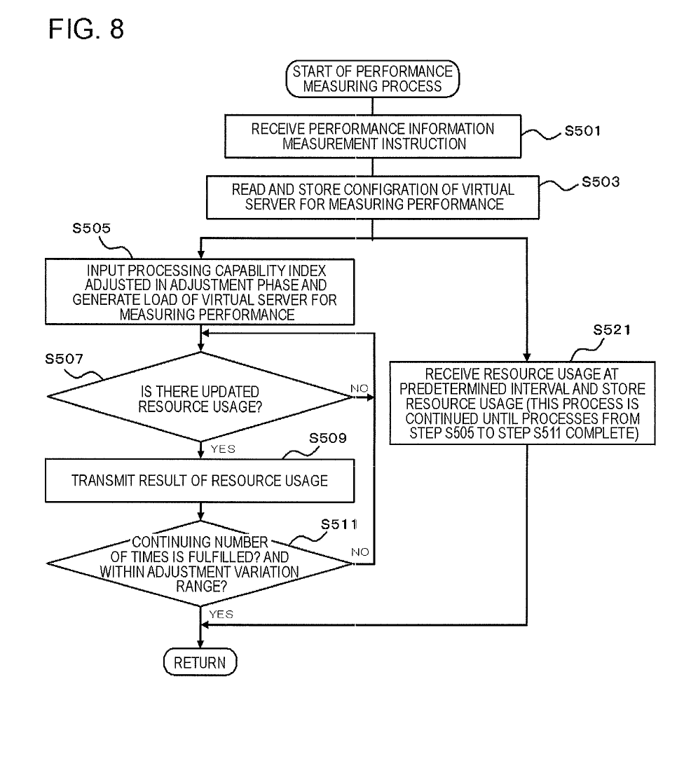

FIG. 8 is a flowchart illustrating an example of the procedure of the performance measuring process of the virtual server for measuring performance 100 according to this exemplary embodiment when the load is reproduced. As described above, the performance measurement program according to this exemplary embodiment allows the computer to perform the following processes, thereby implementing the functions of the virtual server for measuring performance 100 according to this exemplary embodiment. This flow is called from Step S407 of the load reproducing process of the management server 4 according to this exemplary embodiment shown in FIG. 7 in the load reproduction phase. The procedure will be described with reference to FIGS. 1, 3, and 8.

First, in the virtual server for measuring performance 100 (FIG. 3), the information receiving unit 103 (FIG. 3) receives the performance information measurement instruction transmitted from the management server 4 (FIG. 1) in Step S405 of FIG. 7 and stores the performance information measurement instruction in the received information storage unit 121 (FIG. 3) (Step S501 in FIG. 8). Then, in respect to the performance information measurement instruction, the measurement instructing unit 115 (FIG. 3) instructs the configuration file reading unit 109 (FIG. 3) to read the parameters of the set information 130 shown in FIG. 13. In response to the instruction, the configuration file reading unit 109 (FIG. 3) reads the set parameters of the virtual server for measuring performance 100 designated by the set information 130 (FIG. 13) from the received information storage unit 121 and stores the set parameters in the configuration information storage unit 123 (FIG. 3) (Step S503 in FIG. 8).

Then, the measurement instructing unit 115 (FIG. 3) instructs the load generating unit 107 (FIG. 3) to generate a load such that the load is applied to the resources. In response to the instruction, the load generating unit 107 (FIG. 3) performs a process on the basis of the processing capability index of the set information 130 (FIG. 13) stored in the configuration information storage unit 123 (FIG. 3), thereby generating a load for the resources (Step S505 in FIG. 8). Here, the load is applied to all of the resources, regardless of the order in which the load is applied to the resources. As such, when the processing capability index adjusted in the load adjustment phase is input to the load generating unit 107, the load of the virtual server for measuring performance 100 is generated.

In Step S505 of FIG. 8, like the set information 130 shown in FIG. 13, the load generating unit 107 can start processes corresponding to the number of cores from multi-processor information and a plurality of processes can generate loads at the same time. That is, the load generating unit 107 performs a plurality of load generation processes or threads. Then, the estimating unit (load adjusting unit 111) can estimate the processing capability index of the virtual server in a multi-processor environment.

In the case of multiple processors, when the performance measuring program is executed for CPU resources, one process is allocated to one CPU. Therefore, when measurement is performed on two CPUs, a maximum of 50% of CPU resources is used in each server (the move source server 7 or the move destination server 9). When there is a server with multiple CPUs in the environment of the server (the move source server 7 in the load adjustment phase and the move destination server 9 in the load reproduction phase), which is a measurement target, this process is considered to use CPU resources as much as possible. As a result, regardless of whether there is a single CPU or there are multiple CPUs, it is possible to perform comparison with the processing capability index.

In parallel to Steps S505 to S511 in FIG. 8, the information receiving unit 103 (FIG. 3) periodically receives resource usage from the load information notifying unit 94 (FIG. 1) of the management agent 90 (FIG. 1) of the move destination server 9 (FIG. 1) through the communication network 3 (FIG. 1) and stores data for the resource usage in the load information storage unit 117 (FIG. 3) (Step S521 in FIG. 8).

Then, the load determining unit 105 (FIG. 3) checks whether the resource usage in the load information storage unit 117 (FIG. 3) is updated (Step S507 in FIG. 8). When the load determining unit 105 (FIG. 3) determines that there is the updated resource usage in the load information storage unit 117 (FIG. 3) (YES in Step S507 of FIG. 8), the latest resource usage is read from the load information storage unit 117 (FIG. 3) and is then transmitted by the information transmitting unit 101 (FIG. 3) to the management server 4 (FIG. 1) through the communication network 3 (FIG. 1) (Step S509 in FIG. 8).

The absolute values of the latest resource usage and the previous resource usage in the load information storage unit 117 (FIG. 3) are acquired. When the absolute values are within the variation range designated by the set information 130 shown in FIG. 13 and the number of continuations designated by the set information 130 shown in FIG. 13 are satisfied (YES in Step S511 of FIG. 8), this process ends and returns to Step S409 in FIG. 7. In this case, the reception of the resource usage in Step S521 of FIG. 8 is also stopped.

In this way, the performance measuring process of the virtual server for measuring performance 100 ends and returns to Step S409 in FIG. 7. When the conditions are not satisfied (NO in Step S511 of FIG. 8), the process returns to Step S507 in FIG. 8.

As described above, according to the information processing system 1 of this exemplary embodiment, dependence analysis (this is defined as a dependent load) is performed in which, when a load is applied to a given resource, a load is applied to another resource due to, for example, I/O processing on the move source server 7. The analysis result is used to estimate a load corresponding to resource usage which is obtained by subtracting the dependent load from a goal load. In addition, adjustment is performed such that a processing capability index corresponding to the subtracted resource usage is obtained. As a result, it is possible to estimate the processing capability index capable of generating a load which is close to the goal load and corresponds to the resource usage of the move source server 7. The dependence relationship between the resources is analyzed to estimate to a load close to target resource usage, and the estimation accuracy of the load is improved.

For example, when a load is applied to the resources during the estimation of the load of the virtual server, there is the dependence between different resources. Therefore, when the load is reproduced on the basis of the observed resource usage, an extra load is generated from the dependence characteristics. The dependence relationship in other resources when a load is applied to a measurement target resource is analyzed and the dependence numbers are then classified. In order to generate a target resource load, a load is generated for the resources in the order of the dependence on the resources and the load corresponding to resource usage subtracted from the target resource usage is reproduced. In this way, the influence of the overhead between the resources due to the generation of the load is removed and it is possible to prevent the generation of an extra load.

In particular, the dependence relationship in other resources when a load is applied to a measurement target resource is analyzed on the basis of, for example, the resource usages of other resources, and then the resources are classified according to whether any resource has the higher dependence numbers. In order to generate a target resource load, the load applied to other resources when the load is applied in the order of the dependence on the resources is stored. In addition, when a load is generated for other resources, a load obtained by subtracting the above-mentioned load from the target resource usage is reproduced. This is repeatedly performed to generate the target resource usage.

### Second Exemplary Embodiment

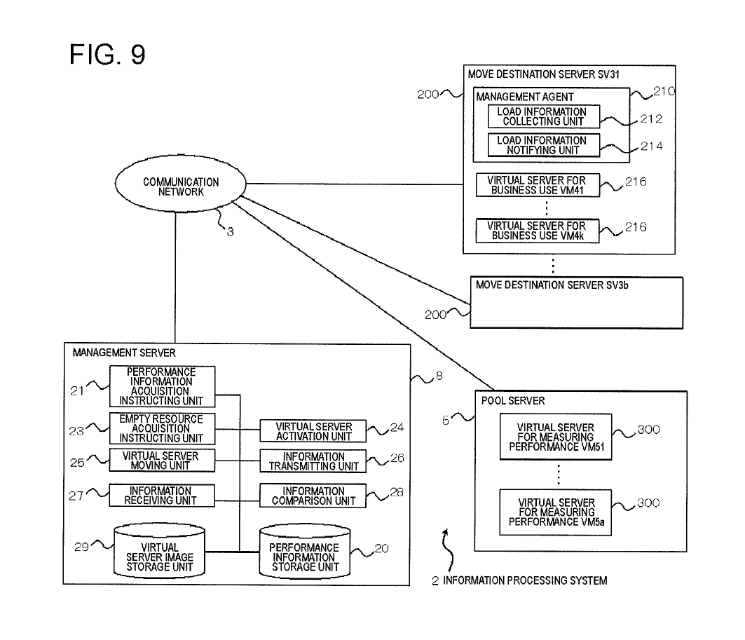

FIG. 9 is a schematic block diagram illustrating the structure of an information processing system 2 according to a second exemplary embodiment of the invention.

The information processing system 2 according to this exemplary embodiment differs from the information processing system 1 according to the first exemplary embodiment in that a physical server with an appropriate load is determined from the physical servers, which are move destination candidates.

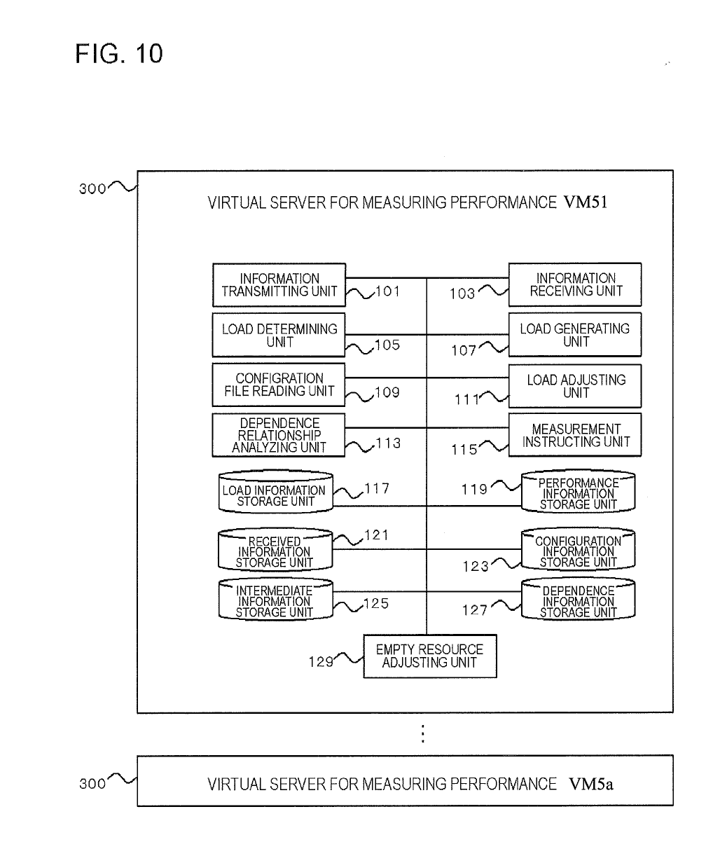

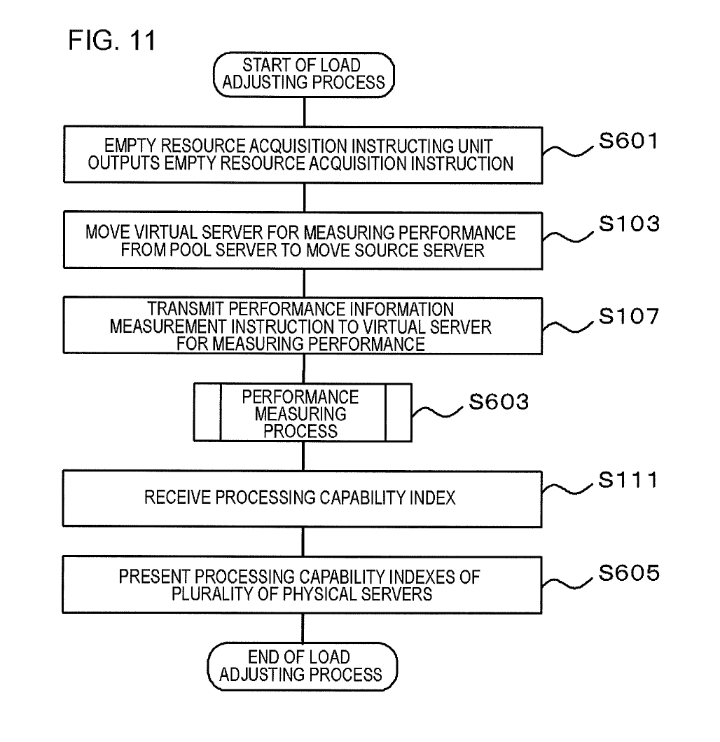

In the information processing system 2 according to this exemplary embodiment, a virtual server for measuring performance 300 is operated on a move destination server 200 to be verified. While a load generating unit 107 (FIG. 10) selects one as a measurement target resource from a plurality of resources in the order of rankings given by a ranking unit (dependence relationship analyzing unit 113 in FIG. 10) and sequentially generates a load to the selected measurement target resource, an empty resource adjusting unit 129 (FIG. 10) adjusts the processing capability index on the basis of the resource usage of each resource acquired by an information receiving unit 103 (FIG. 10) such that resource usage obtained by subtracting the resource usage of the measurement target resource to which the load is currently applied by the load generating unit 107 corresponding to the resource usage of the resources which are other than the current measurement target resource and to which the load has been previously applied by the load generating unit 107, from a predetermined target resource usage corresponding to the empty capacity of the virtual server, is acquired. A control device (virtual server for measuring performance 300) includes: a determining unit (load determining unit 105 in FIG. 10) that determines whether the absolute value of the resource usage corresponding to the empty capacity of the move source server 200 is within the allowable range from the resource usage acquired by the information receiving unit 103 while the load generating unit 107 selects one as the measurement target resource from a plurality of resources in the order of the rankings given by the ranking unit (dependence relationship analyzing unit 113) on the basis of the processing capability index adjusted by a load adjusting unit 111 (FIG. 11) and sequentially generates the load; and an estimating unit (empty load adjusting unit 129) that estimates the processing capability index corresponding to the resource usage which corresponds to the empty capacity of the move source server 200 from the resource usage acquired by the information receiving unit 103 when the load determining unit 105 determines that it is within the allowable range.

Specifically, the information processing system 2 according to this exemplary embodiment includes a management server 8 that includes an empty resource acquisition instructing unit 23, instead of the load adjustment and reproduction instructing unit 22 of the information processing system 1 according to the first exemplary embodiment shown in FIG. 1, a pool server 5 that includes a plurality of virtual servers for measuring performance 300, instead of a plurality of the virtual servers for measuring performance 100 of the information processing system 1 according to the first exemplary embodiment shown in FIG. 1, and a move destination server 200 which are connected to each other through a communication network 3.

A plurality of move destination servers 200 (SV31, . . . , SV3b; b is a natural number) have the same structure as the move destination servers 9 (SV21, . . . , SV2m; m is a natural number) of the information processing system 1 shown in FIG. 1. Each of the move destination servers 200 includes a management agent 210 including a load information collecting unit 212 and a load information notifying unit 214, similarly to the management agent 90.

In FIG. 9, the pool server 5 and the move destination servers 200 (SV31, SV3b) are physical servers in which virtual servers can be provided and which have a function capable of moving therebetween. There are two types of virtual servers. One type is virtual servers for business use 216 (VM41, . . . , VM4k; k is a natural number) and the other type is virtual servers for measuring performance 300 (VM51, . . . , VM5a; “a” is a natural number).

It is assumed that the virtual server for business use 216 includes applications for executing, for example, Web, mail, and backup and processes them. The virtual server for measuring performance 300 according to this exemplary embodiment is operated on the pool server 5. Like the virtual servers for measuring performance 300 (VM51 to VM5a) shown in FIG. 9, a plurality of (a) virtual servers for measuring performance may be operated on the pool server 5.

The management agent 210 of the move destination server 200 includes the load information collecting unit 212 and the load information notifying unit 214 and instructs the units to start or end their functions. The virtual server for business use 216 is operated on the move destination server 200. In this exemplary embodiment, a plurality of (k1, k2, . . . , kb) virtual servers for business use 216 may be operated on each move destination server 200 (in FIG. 9, only virtual servers for business use VM41 to VM4k are shown).

In the management server 8 according to this exemplary embodiment, a performance information acquisition instructing unit 21 instructs an empty resource acquisition instructing unit 23 to acquire empty resources. In this exemplary embodiment, similarly to the first exemplary embodiment, the operator can use, for example, an operation unit (not shown) to input an empty resource acquisition instruction to the management server 8 of the information processing system 2. The performance information acquisition instructing unit 21 instructs the empty resource acquisition instructing unit 23 to acquire empty resources, in response to the instruction. In this case, the move destination server 200 to be verified is designated by the operator.

The empty resource acquisition instructing unit 23 of the management server 8 receives the empty resource acquisition instruction from the performance information acquisition instructing unit 21. Then, in response to the instruction, the empty resource acquisition instructing unit 23 instructs the virtual server moving unit 25 to move the virtual server for measuring performance 300 from the pool server 5 to the move destination server 200 to be verified. In addition, the empty resource acquisition instructing unit 23 transmits a performance information measurement instruction to the virtual server for measuring performance 300 moved to the move destination server 200 through the communication network 3 using the information transmitting unit 26. The performance information measurement instruction is the same as that in the first exemplary embodiment.

The functions of each unit of the management server 8 are implemented by the execution of a computer program by the computer. The computer program may be recorded on a computer-readable recording medium. The recording medium is not particularly limited, but various recording media may be considered. The program may be loaded from the recording medium to the memory of the computer, or it may be downloaded to the computer through the network and then loaded to the memory.

FIG. 10 is a functional block diagram illustrating the structure of the virtual server for measuring performance 300 according to this exemplary embodiment.

Specifically, as shown in FIG. 10, the virtual server for measuring performance 300 according to this exemplary embodiment includes the empty resource adjusting unit 129 in addition to the structure of the virtual server for measuring performance 100 according to the first exemplary embodiment shown in FIG. 3. In FIG. 10, the virtual server for measuring performance VM51 is shown, but the other virtual servers for measuring performance VM5a have the same structure as the virtual server for measuring performance VM51.

The empty resource adjusting unit 129 adjusts the processing capability index on the basis of the resource usage of each resource which is acquired by the information receiving unit 103 such that resource usage obtained by subtracting the resource usage of the measurement target resource to which the load is currently applied by the load generating unit 107 corresponding to the resource usage of the resources which are other than the current measurement target resource and to which the load has been previously applied by the load generating unit 107, from a predetermined target resource usage corresponding to the empty capacity of the virtual server, is acquired, while the load generating unit 107 selects one as the measurement target resource from a plurality of the resources in the order of the rankings given by the ranking unit (the dependence relationship analyzing unit 113) and sequentially generates the load. In addition, when the load determining unit 105 determines that the absolute value is within the allowable range, the empty resource adjusting unit 129 estimates the processing capability index corresponding to the resource usage which corresponds to the empty capacity of the physical server from the resource usage acquired by the information receiving unit 103.

The functions of each unit of the virtual server for measuring performance 300 are implemented by the execution of the computer program by the computer.

The computer program according to this exemplary embodiment allows the computer for implementing the virtual server for measuring performance 300 to perform, in addition to the procedures according to the above exemplary embodiment: a procedure of operating the virtual server for measuring performance 300 on the move destination server 200 to be verified; a procedure of adjusting the processing capability index on the basis of the resource usage of each resource acquired in the acquiring process such that resource usage obtained by subtracting the resource usage of the measurement target resource to which the load is currently applied in the load generation process corresponding to the resource usage of the resources which are other than the current measurement target resource and to which the load has been previously applied in the load generation process, from a predetermined target resource usage corresponding to the empty capacity of the move destination server 200, is acquired, while the load generation process selects one as the measurement target resource from a plurality of the resources in the order of the rankings given in the ranking process and sequentially generates the load to the selected measurement target resource; a procedure of determining whether the absolute value of the resource usage corresponding to the empty capacity of the move destination server 200 is within the allowable range from the resource usage acquired in the acquiring process while the load generation process selects one as the measurement target resource from a plurality of the resources in the order of the rankings given in the ranking process on the basis of the processing capability index adjusted in the adjusting process and sequentially generates the load; and a procedure of estimating the processing capability index corresponding to the resource usage which corresponds to the empty capacity of the move destination server 200 from the resource usage acquired in the acquiring process when it is determined in the determining process that it is within the allowable range. Hereinafter, this program is referred to as a performance measurement program.

The computer program according to this exemplary embodiment may be recorded on a computer-readable storage medium. The recording medium is not particularly limited, but various recording media may be considered. The program may be loaded from the recording medium to the memory of the computer, or it may be downloaded to the computer through the network and then loaded to the memory.

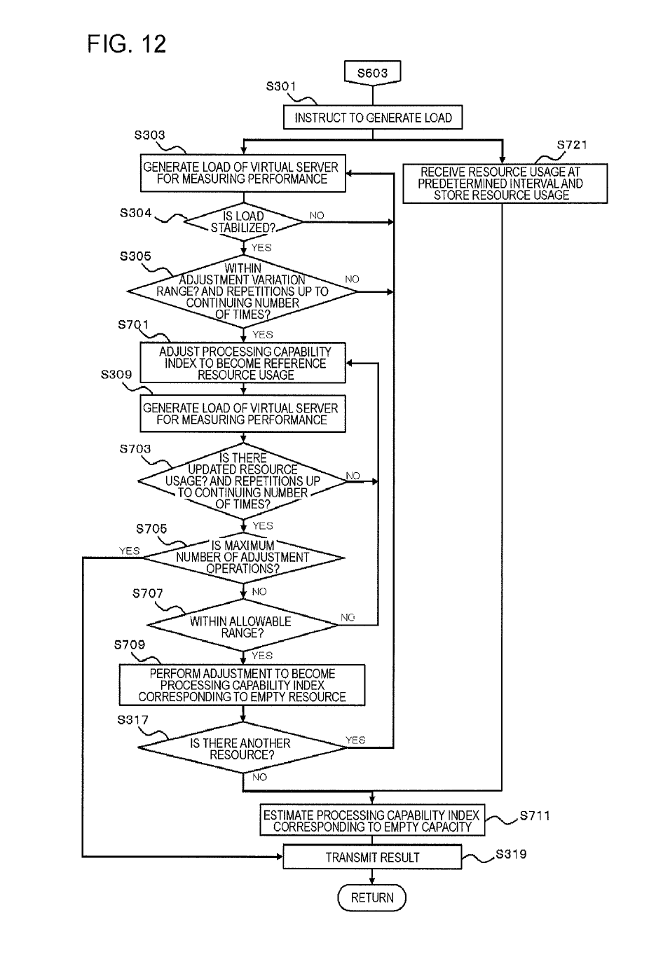

In the above-mentioned structure, a data processing method of the control device according to this exemplary embodiment will be described. FIGS. 11 and 12 are flowcharts illustrating an example of the operation of the information processing system 2 according to this exemplary embodiment.

The data processing method of the control device (virtual server for measuring performance 300) according to this exemplary embodiment is performed as follows in the data processing method of the control device according to the first exemplary embodiment. The virtual server for measuring performance 300 is operated on the move destination server 200 to be verified. While the measurement target resource is selected from a plurality of resources in the order of the rankings and the load is sequentially generated (Step S303 in FIG. 12), the processing capability index is adjusted on the basis of the acquired usage of each resource such that resource usage obtained by subtracting the resource usage of the measurement target resource to which the load is currently applied corresponding to the resource usage of the resources which are other than the current measurement target resource and to which the load has been previously applied, from a predetermined target resource usage corresponding to the empty capacity of the physical server, is acquired (Step S701 in FIG. 12). While selecting one as the measurement target resource from a plurality of resources in the order of the rankings on the basis of the adjusted processing capability index (Step S317 in FIG. 12) and sequentially generating the load to the selected measurement target resource (Step S309 in FIG. 12), it is determined whether the absolute value of the resource usage corresponding to the empty capacity of the physical server is within the allowable range from the acquired resource usage (Steps S703 to S707 in FIG. 12). When it is determined that it is within the allowable range (YES in Step S707 of FIG. 12), the processing capability index corresponding to the resource usage which corresponds to the empty capacity of the move destination server 200 is estimated from the acquired resource usage (Step S709 in FIG. 12). That is, the load generating unit 107 (FIG. 10) adjusts the processing capability index such that a processing capability index corresponding to the empty resource is obtained from the reference processing capability index.

Next, the operation of the information processing system 2 according to this exemplary embodiment having the above-mentioned structure will be described with reference to FIGS. 9 to 12.

In the following description, it is assumed that the move destination server 200 includes one virtual server for measuring performance 300 and a plurality of virtual servers for business use 216 (VM41 to VM4k). In addition, it is assumed that the empty resource of the move destination server 200 is acquired. It is assumed that, in the management server 8, the images of two types of virtual servers, that is, the virtual server for measuring performance 300 and the virtual server for business use 216 are registered in the virtual server image storage unit 29. The virtual server activation unit 24 starts the virtual server for measuring performance 300 on the pool server 5 in advance. Like the virtual servers for measuring performance 300 (VM51 to VM5a), a plurality of virtual servers may start up.

In the move destination server 200, a plurality of virtual servers for business use 216 (VM41 to VM4k) starts up. It is assumed that the load is generated by a client process or a job scheduling process and the resources of the move destination server 200 are consumed. Like the virtual servers for business use 216 (VM41 to VM4k, VM61 to VM6k, . . . , VM71 to VM7k), a plurality of virtual servers may start up. It is assumed that the operator uses the operation unit (not shown) to input an empty resource acquisition instruction and the performance information acquisition instructing unit 21 receives the instruction. The maximum capacity of each resource usage is generally determined by the benchmark results.

First, in the management server 8 (FIG. 9), when receiving the empty resource acquisition instruction from the operator, the performance information acquisition instructing unit 21 (FIG. 9) instructs the empty resource acquisition instructing unit 23 (FIG. 9) to instruct acquire an empty resource (Step S601 in FIG. 11).

In response to the empty resource acquisition instruction, the empty resource acquisition instructing unit 23 (FIG. 9) instructs the virtual server moving unit 25 (FIG. 9) to move the virtual server for measuring performance 300 (FIG. 9) on the pool server 5 to the move destination server 200 (FIG. 9) designated by the user. Measurement is not performed on the move destination server 200 which is not designated by the user. In response to the instruction, the virtual server for measuring performance 300 (FIG. 9) is moved from the pool server 5 (FIG. 9) to the move destination server 200 (FIG. 9) (Step S103 in FIG. 11).

Then, the empty resource acquisition instructing unit 23 (FIG. 9) transmits a performance information measurement instruction to the virtual server for measuring performance 300 (FIG. 9) using the information transmitting unit 26 (FIG. 9) (Step S107 in FIG. 9). The performance measuring process of the virtual server for measuring performance 300 (FIG. 9) will be described in detail below.

When the performance measuring process (Step S603 in FIG. 11) of the virtual server for measuring performance 300 (FIG. 9) ends, the information receiving unit 27 (FIG. 9) receives the processing capability index from the virtual server for measuring performance 300 (FIG. 9) on each move destination server 200 (FIG. 9) in the management server 8. The processing capability indexes measured by all of the move destination servers 200, which are measurement targets, are received and stored in the performance information storage unit 20 (FIG. 9) (Step S111 in FIG. 11).

The information comparison unit 28 (FIG. 9) acquires the capability indexes measured by the move destination servers 200 (FIG. 9) which are stored in the performance information storage unit 20 (FIG. 9). When the measuring process is performed on a plurality of move destination servers 200 (SV31 to SV3b) (FIG. 9), the information comparison unit 28 presents the processing capability indexes to, for example, a display unit (not shown) such that the processing capability indexes are compared with each other for each move destination server 200 (Step S605 in FIG. 11). In this way, the operator can determine whether there is an empty resource in each move destination server 200 (SV31 to SV3b) on the basis of the processing capability indexes.

In this exemplary embodiment, the management server 8 may include a selection unit (not shown) that sequentially operates the virtual server for measuring performance 300 on the move destination servers 200, which are a plurality of move destination candidates, and selects the move destination server 200 as a verification target on the basis of the processing capability index obtained by the estimating unit (load adjusting unit 111). The operator can use the operation unit (not shown) to input an instruction to select the move destination server 200, with reference to the processing capability index which is presented to the display unit (not shown) by the same presenting unit as that in the first exemplary embodiment. Alternatively, conditions may be given to the processing capability indexes and the move destination candidate satisfying the conditions may be automatically selected as the move destination server 200.

Next, a performance measuring process of the virtual server for measuring performance 300 according to this exemplary embodiment will be described. In the performance measuring process of the virtual server for measuring performance 300 according to this exemplary embodiment, first, the same dependence relationship analysis process as that shown in FIG. 5 in the virtual server for measuring performance 100 (FIG. 3) according to the first exemplary embodiment starts. Steps S201 to S213 and Step S221 shown in FIG. 5 are performed to analyze the dependence relationship between the resources. When the dependence relationship analysis process ends, the load estimating process shown in FIG. 12 starts on the basis of the dependence relationship obtained by the dependence relationship analysis process. FIG. 12 is a flowchart illustrating an example of the procedure of the load estimating process in the performance measuring process of the virtual server for measuring performance 300 according to this exemplary embodiment. As described above, the performance measurement program according to this exemplary embodiment allows the computer to perform the following processes, thereby implementing the functions of the virtual server for measuring performance 300 according to this exemplary embodiment, which will be described with FIGS. 10 and 12.

The load estimating process shown in FIG. 12 includes Steps S301 to S305, Step S309, Step S317, and Step S319 which are the same as those shown in FIG. 6 and further includes Steps S701 to S711 and Step S721.

First, the measurement instructing unit 115 (FIG. 10) instructs the load generating unit 107 (FIG. 10) to generate a load such that the load is applied in the order (descending order) of the value of the dependence numbers stored in the dependence information storage unit 127 (FIG. 10) (Step S301 in FIG. 12). The reason is as follows. In the structure in which the load is applied to the resources in descending order of the dependence numbers, when the load is applied to another resource with the small dependence numbers, it is possible to generate and reach a goal load while absorbing the previous dependent load. When the load is applied to the resources in ascending order of the dependence numbers, the load will be more than the goal load later. The intensity of the generated load is defined as the processing capability index. As shown in FIG. 14, the generation of the load and the stopping (sleep) of the generation of the load are repeatedly performed within a predetermined period to adjust the resource usage that is output.

Then, the load generating unit 107 (FIG. 10) generates a load with the resources to be measured, with reference to each resource flag of the set information 130 shown in FIG. 13 (Step S303 in FIG. 12). In the first operation, a resource load is generated on the basis of the first processing capability index set in the set information 130. In the second and subsequent operations, the resource load is generated on the basis of the processing capability index updated by the process, which will be described below. No process is performed on the resources which are not measured. In this exemplary embodiment, when the processing capability index is input to the load generating unit 107, the load of the virtual server for measuring performance 100 is generated.

In Step S303 of FIG. 12, the load generating unit 107 starts processes corresponding to the number of cores from multi-processor information, like the set information 130 shown in FIG. 13, and a plurality of processes can generate loads at the same time. That is, the load generating unit 107 performs a plurality of load generation processes or threads. Then, the estimating unit (load adjusting unit 111) can estimate the processing capability index of the virtual server in a multi-processor environment.

In the case of multiple processors, when the performance measuring program is executed for CPU resources, one process is allocated to one CPU. Therefore, when measurement is performed on two CPUs, a maximum of 50% of CPU resources is used in each server (the move source server 7 or the move destination server 9). When there is a server with multiple CPUs in the environment of the server (the move source server 7 in the load adjustment phase and the move destination server 9 in the load reproduction phase), which is a measurement target, this process is considered to use CPU resources as much as possible. As a result, regardless of whether there is a single CPU or there are multiple CPUs, it is possible to perform comparison with the processing capability index.

In this exemplary embodiment, the resources correspond to the CPU, the memory, the NW, and the HDD and are calculated as resource usage or a usage rate. The usage rate is known from the resource usage of the physical server and the virtual server within a predetermined period. For example, the NW alternately performs an NW input and output process per second and the sleep process for a predetermined period to control the load which is generated at the same time as the load is generated in the CPU. The HDD alternately performs a reading and writing process per second and the sleep process for a predetermined period to control the load which is generated at the same time as the load is generated in the CPU. The resources are not limited to the above, but other dependent resources may be measured.

In parallel to Steps S303 to S317 in FIG. 12, the information receiving unit 103 (FIG. 10) periodically receives resource usage from the load information notifying unit 214 (FIG. 9) of the management agent 210 (FIG. 9) of the move destination server 200 (FIG. 9) through the communication network 3 (FIG. 9) and stores the resource usage in the load information storage unit 117 (FIG. 10). In the move destination server 200 (FIG. 9), it is assumed that the load information collecting unit 212 (FIG. 9) of the management agent 210 (FIG. 9) periodically transmits the acquired resource usage of the move destination server 200 (FIG. 9), and each virtual server for measuring performance 300 (FIG. 9) and each virtual server for business use 216 (FIG. 9) operated on the move destination server 200 to the information receiving unit 103 (FIG. 10) of the virtual server for measuring performance 300 (FIG. 10) through the communication network 3 (FIG. 9) (Step S721 in FIG. 12).

Then, the load determining unit 105 (FIG. 10) determines whether the load of the measurement target resource is stabilized (Step S304 in FIG. 12). For example, first, the load determining unit 105 (FIG. 10) checks whether the resource usage of the measurement target resource (periodically updated in Step S721 of FIG. 12) in the load information storage unit 117 (FIG. 10) is updated. When any one is not updated, the process returns to Step S303 in FIG. 12. When there is the updated resource usage and the number of skip operations reaches a predetermined value set in the set information 130 shown in FIG. 13, it is determined that the load is stabilized (YES in Step S304 of FIG. 12) and the load determining unit 105 (FIG. 10) adopts the updated resource usage. When the number of skip operations does not reach the predetermined value, it is determined that the load has not been stabilized (NO in Step S304 of FIG. 12), and the process returns to Step S303 in FIG. 12.

The load determining unit 105 (FIG. 10) compares the latest resource usage and the previous resource usage of the virtual server for measuring performance 300 and determines whether the difference therebetween is within the first adjustment variation range of the set information 130 shown in FIG. 13. When the difference is within the range, the load determining unit determines whether measurement is continuously performed a predetermined number of times stored in the set information 130 shown in FIG. 13 (Step S305 in FIG. 12). When the conditions are not satisfied (NO in Step S305 of FIG. 12), the process returns to Step S303 in FIG. 12.

When the conditions are satisfied (YES in Step S305 of FIG. 12), the load adjusting unit 111 (FIG. 10) uses the first processing capability index of the set information 130 shown in FIG. 13 as the base in the first operation and associates the updated processing capability index with the resource usage of the virtual server for measuring performance 300 in the second or subsequent operations. Here, the load adjusting unit 111 adjusts the processing capability index such that the reference resource usage of the set information 130 shown in FIG. 13 is obtained. The following Mathematical Expression (4) is used (Step S701 in FIG. 12).

Mathematical Expression (4) defines a numerical expression used in the load adjustment phase or the load reproduction phase according to this exemplary embodiment.

Mathematical Expression (4) defines the adjustment of a processing capability index (NUM_BSE) such that reference resource usage (P_BSE) is obtained from the load information (P_AVM) of the virtual server for measuring performance 300 which is output by the first processing capability index (NUM_FST).

NUM_{—}BSE=NUM_{—}FST×(P_{—}BSE/P_{—}AVM) Math. (4)

The load generating unit 107 (FIG. 10) generates a load for the resources of the virtual server for measuring performance 300 on the basis of the processing capability index (Step S309 in FIG. 12). In this case, when the processing capability index is input to the load generating unit 107, the load of the virtual server for measuring performance 100 is generated.

When it is checked that the resource usage of the load information storage unit 117 (FIG. 10) is updated and measurement is continuously performed a predetermined number of times set in the set information 130 shown in FIG. 13 (YES in Step S703 of FIG. 12), the load determining unit 105 (FIG. 10) adopts the resource usage. When there is no updated resource usage in the load information storage unit 117 or when the number of continuations does not reach the predetermined value (NO in Step S703 of FIG. 12), the process returns to Step S701 in FIG. 12.

The load determining unit 105 (FIG. 10) determines whether the number of times the processing capability index is adjusted in order to obtain the reference resource usage, that is, the maximum number of adjustment operations set in the set information 130 shown in FIG. 13 is satisfied (Step S705 in FIG. 12). When the maximum number of adjustment operations is satisfied (YES in Step S705 of FIG. 12), the determination result including the content of an error is transmitted to the management server 8 through the communication network 3 (FIG. 9), and the process returns to Step S111 in FIG. 11 (Step S319 in FIG. 12).

When the determination result in Step S705 of FIG. 12 is NO, the load determining unit 105 (FIG. 10) associates the processing capability index with the resource usage of the virtual server for measuring performance 300 and determines whether the resource usage is within the allowable range of the reference resource usage set in the set information 130 shown in FIG. 13 (Step S707 in FIG. 12). When the conditions are satisfied (YES in Step S707 of FIG. 12), the process proceeds to the next Step S709 in FIG. 12. When the conditions are not satisfied (NO in Step S707 of FIG. 12), the process returns to Step S701 in FIG. 12.

The processing capability index for generating a load corresponding to resource usage obtained by subtracting dependent resource usage, which is a measurement target, from empty resource usage is estimated from the reference processing capability index by the following Mathematical Expression (5), with reference to the resource usage of measurement target data in the intermediate information storage unit 125 (FIG. 10). When there is no resource usage of the measurement target data as the result of the reference, the resource usage in the intermediate information storage unit 125 is not used.

The following Mathematical Expression (5) defines a numerical expression used in the load adjustment phase or the load reproduction phase according to this exemplary embodiment.

The following Mathematical Expression (5) defines resource usage (P_CAP) corresponding to empty capacity which is obtained by subtracting the current resource usage (P_AVM) of a performance measure virtual server from the resource usage (P_ALL) of all servers including the resource usage (P_SV) of the host, the resource usage (ΣP_VM*) of the virtual servers other than the performance measure virtual server, P_SV, and P_VM after the load is output using the reference processing capability index (where * indicates all relevant servers).

P_{—}CAP=P_{—}ALL−{(P_{—}SV+ΣP_{—}VM*)−P_{—}AVM} Math. (5)

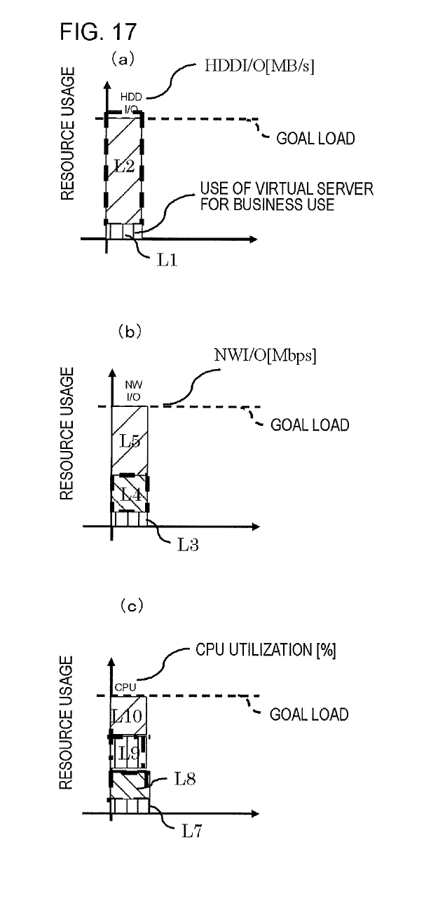

FIG. 17 shows an example of a method of estimating each resource load from the dependence characteristics of the load in descending order of the dependence numbers shown in FIG. 15 (HDDI/O>NWI/O>CPU=memory). A goal load is resource usage when the empty resource of the move destination server 200 is used completely except for the load of the virtual server for business use 216 (FIG. 10). In FIG. 17, the load generated by HDDI/O is a portion surrounded by a bold dashed line and the load generated by NWI/O is a portion surrounded by a bold one-dot chain line.

As shown in FIG. 17(a), when the load of HDDI/O is generated, particularly, there is no dependence relationship. The processing capability index corresponding to the resource usage of a portion (L2) obtained by subtracting the resource usage of a portion (L1) used by the virtual server for business use from the goal load is estimated.

When HDDI/O_M is HDDI/O usage (L1+L2) corresponding to the maximum capacity of the physical server and HDDI/O_VM is HDDI/O usage (L1) generated by the virtual server for business use, HDDI/O_E, which is HDDI/O usage (L2) corresponding to the empty capacity of the physical server, is represented by the following Mathematical Expression (6).

HDDI/O_{—}E=HDDI/O_{—}M−HDDI/O_{—}VM Math. (6)

As shown in FIG. 17(b), during the estimation of the load of NWI/O, when the load of HDDI/O is generated, the load (L4) of NWI/O is also generated. Therefore, the processing capability index corresponding to the resource usage of a portion (L5) obtained by subtracting the resource usage of the portion (L4) and the resource usage of a portion (L3) used by the virtual server for business use from the goal load is estimated.

When NWI/O_M is NWI/O usage (L3+L4+L5) corresponding to the maximum capacity of the physical server, NWI/O_HDDI/O is NWI/O usage (L4) generated by the load of HDDI/O, and NWI/O_VM is NWI/O usage (L3) generated by the virtual server for business use, NWI/O_E, which is NWI/O usage (L5) corresponding to the empty capacity of the physical server, is represented by the following Mathematical Expression (7).

NWI/O_{—}E=NWI/O_{—}M−{NWI/O_{—}HDDI/O+NWI/O_{—}VM} Math. (7)

As shown in FIG. 17(c), during the estimation of a CPU load, a CPU load (L9) is generated when the load of HDDI/O is generated and a CPU load (L8) is generated when the load of NWI/O is generated. Therefore, the processing capability index corresponding to the resource usage of a portion (L10) obtained by subtracting the resource usage of portions (L9) and (L8) and the resource usage of a portion (L7) used by the virtual server for business use from the goal load is estimated.

When CPU_M is CPU usage (L7+L8+L9+L10) corresponding to the maximum capacity of the physical server, CPU_HDDI/O is CPU usage (L9) generated by the load of HDDI/O, CPU_NWI/O is CPU usage (L8) generated by the load of NWI/O, and CPU_VM is CPU usage (L7) generated by the virtual server for business use, CPU_E, which is CPU usage (L10) corresponding to the empty capacity of the physical server, is represented by the following Mathematical Expression (8).

CPU_{—}E=CPU_{—}M−{CPU_{—}NWI/O+CPU_{—}HDDI/O+CPU_{—}VM} Math. (8)

In this way, it is possible to estimate the processing capability index for target resource usage (Step S709 in FIG. 12).

The load adjusting unit 111 (FIG. 10) stores the processing capability index of the measurement target in the performance information storage unit 119 (FIG. 10) and stores the resource usage other than the measurement target at that time in the intermediate information storage unit 125 (FIG. 10). When there is measurement target resource for which a load has not been generated (YES in Step S317 of FIG. 12), the process returns to Step S303 in FIG. 12 and the measurement of the target is stopped. Then, another resource is measured. When there is no measurement target resource for which a load has not been generated (NO in Step S317 of FIG. 12), the process proceeds to the next Step S711 in FIG. 12. In this case, the reception of the resource usage in Step S721 of FIG. 12 is also stopped and the process proceeds to Step S711 in FIG. 12.

As described above, the empty resource adjusting unit 129 calculates resource usage corresponding to empty capacity, estimates the processing capability index corresponding to the empty capacity which corresponds to the resource usage, and stores the processing capability index in the performance information storage unit 119 (FIG. 10) (Step S711 in FIG. 12).

Then, the information transmitting unit 101 is used to transmit the processing capability index stored in the performance information storage unit 119 (FIG. 10) as the result to the management server 8 (Step S319 in FIG. 12).

In this way, the load estimating process of the virtual server for measuring performance 300 ends and the process returns to Step S111 in FIG. 11.

As described above, according to the information processing system 2 of this exemplary embodiment, the same effect as that of the information processing system 1 according to the first exemplary embodiment is obtained, and dependence analysis (this is defined as a dependent load) is performed in which, when a load is applied to a given resource, a load is applied to another resource due to, for example, I/O processing on the move source server 7. The analysis result is used to estimate a load corresponding to resource usage which is obtained by subtracting the dependent load from the goal load. In addition, adjustment is performed such that the processing capability index capable of generating the load corresponding to the subtracted resource usage is obtained. As a result, it is possible to estimate resource usage corresponding to the empty capacity with accuracy close to a target level. As such, the dependence relationship between the resources is analyzed to estimate to a load close to target resource usage, and the estimation accuracy of the load is improved.

The exemplary embodiments of the invention have been described above with reference to the drawings, but are illustrative examples of the invention. Various structures other than the above-described exemplary embodiments may be used.

For example, the following Mathematical Expression (9) defines a numerical expression used in the load adjustment and reproduction unit in the invention.

The following Mathematical Expression (9) defines a processing capability index (NUM_CAP) corresponding to empty capacity from the processing capability index (NUM_BSE) of the virtual server for measuring performance at the present time, resource usage (P_AVM), resource usage (P_CAP) corresponding to empty capacity, and the dependent resource usage (P_DEP) of each measurement target.

NUM_{—}CAP=NUM_{—}BSE×((P_{—}CAP−ΣP_{—}DEP)/P_{—}AVM) Math. (9)

The I/O overhead characteristics of NWI/O and HDDI/O used by the physical machine which is not generated on the physical machine disclosed in Patent Document 1 are examined. The overhead and the CPU utilization of the application used by the physical server are used to the CPU utilization of the virtual machine after the integration of the servers. The load corresponding to I/O is used, but purposes and the estimation method are different. Therefore, the invention is different from the content disclosed in Patent Document 1.

In the virtual server for measuring performance 100 according to the above-described exemplary embodiment, in Step S205 of FIG. 5, the load generating unit 107 considers the CPU, the memory, NWI/O, and HDDI/O as the resources. However, other resources which are dependent on each other may be observed. When the load for the resources can be adjusted, the resources are not limited to the above-mentioned resources, and adjustment may be repeated the number of times corresponding to the number of resources. In addition, the virtual server for measuring performance 100 may analyze the dependence between the resources, adjust the processing capability index, generate a load, and estimate the processing capability index of a goal load.

According to this structure, the invention can be applied to various resources.

In the virtual server for measuring performance 100 according to the above-described exemplary embodiment, in Step S303 of FIG. 6, the load generating unit 107 considers the CPU, the memory, NWI/O, and HDDI/O as the resources. However, other resources which are dependent on each other may be observed. When the load for the resources can be adjusted, the resources are not limited to the above-mentioned resources, and adjustment may be repeated the number of times corresponding to the number of resources. In addition, the virtual server for measuring performance 100 may analyze the dependence between the resources, adjust the processing capability index, generate a load, and estimate the processing capability index of a goal load.

For example, in the virtual server for measuring performance 300 according to the above-described exemplary embodiment, in Step S303 of FIG. 12, the load generating unit 107 considers the CPU, the memory, NWI/O, and HDDI/O as the resources. However, other resources which are dependent on each other may be observed. When the load for the resources can be adjusted, the resources are not limited to the above-mentioned resources, and adjustment may be repeated the number of times corresponding to the number of resources. In addition, the virtual server for measuring performance 300 may analyze the dependence between the resources, adjust the processing capability index, generate a load, and estimate the processing capability index of a goal load.

The invention has been described above with reference to the exemplary embodiments, but is not limited to the above-described exemplary embodiments. It will be understood by those skilled in the art that various modifications and changes of the structure or details of the invention can be made without departing from the scope of the invention.

This application is based on Japanese patent application No. 2010-041476, filed Feb. 26, 2010, the whole contents of which are incorporated hereinto by reference.

1. A control device comprising:
an acquiring unit which acquires respective resource usages of a plurality of resources with respect to a physical server and a virtual server which is operated on said physical server;
a load generating unit which generates a load for a measurement target resource;
a dependence number calculating unit which applies said load to said measurement target resource to acquire resources on which said measurement target resource depends, and calculate dependence numbers of said measurement target resource on the basis of the number of resources on which said measurement target resource depends;
a ranking unit which ranks a plurality of said resources in descending order of said dependence numbers which is calculated for respective resources as said measurement target resource; and
an adjusting unit which adjusts a processing capability index of said resource usage of said measurement target resource while sequentially selecting one as said measurement target resource from a plurality of said resources in the order of the rankings given by said ranking unit, and sequentially applying said load to the selected measurement target resource by said load generating unit.

2. The control device according to claim 1, further comprising:
a detecting unit which detects whether said resource usage of any resource other than said measurement target resource is increased or decreased on the basis of said resource usage acquired by said acquiring unit while said load is applied by said load generating unit; and
a discriminating which determines that the resources depend on said measurement target resource when said detecting unit detects that said resource usage of some resource other than said measurement target resource is increased or decreased,
wherein said dependence number calculating unit counts the number of resources which are determined to depend on said measurement target resource by said discriminating unit and calculates said dependence numbers.

3. The control device according to claim 1,
wherein, instead of at least one virtual server operated on said physical server, a virtual server for measuring performance configured to implement said units of said control device is operated on said physical server, which is a move source,
said load generating unit generates said load on said physical server, instead of said at least one virtual server operated on said physical server, which is said move source,
said acquiring unit periodically acquires said respective resource usages of a plurality of said resources with respect to said physical server and said virtual server for measuring performance operated on said physical server, and
said adjusting unit adjusts said processing capability index.

4. The control device according to claim 3,
wherein said adjusting unit adjusts said processing capability index on the basis of said resource usage of each resource which is acquired by said acquiring unit such that resource usage obtained by subtracting said resource usage of said measurement target resource, to which said load is currently applied by said load generating unit, corresponding to said resource usage of any other resources which are other than current measurement target resource and to which said load has been previously applied by said load generating unit, from a predetermined target resource usage of said measurement target resource of virtual server, is acquired as said resource usage of current measurement target resource, and
said control device further includes:
a determining unit that determines whether said resource usage acquired by said acquiring unit is within an allowable range of said target resource usage while said load generating unit selects one as said measurement target resource from a plurality of said resources in the order of the rankings given by said ranking unit on the basis of said processing capability index adjusted by said adjusting unit and sequentially generates said load; and
an estimating unit that estimates said processing capability index corresponding to said target resource usage from said resource usage acquired by said acquiring unit when said determining unit determines that it is within said allowable range.

5. The control device according to claim 3,
wherein said virtual server for measuring performance is operated on a physical server to be verified,
while said load generating unit selects one as said measurement target resource from a plurality of said resources in the order of the rankings given by said ranking unit and sequentially generates said load to the selected measurement target resource,
said adjusting unit adjusts said processing capability index on the basis of said resource usage of each resource which is acquired by said acquiring unit such that resource usage obtained by subtracting said resource usage of said measurement target resource, to which said load is currently applied by said load generating unit, corresponding to said any other resource usage of said resources which are other than current measurement target resource and to which said load has been previously applied by said load generating unit, from a predetermined target resource usage corresponding to empty capacity of said physical server, is acquired as said resource usage of current measurement target resource, and
said control device further includes:
a determining unit which determines whether said resource usage acquired by said acquiring unit is within an allowable range of said resource usage corresponding to said empty capacity of said physical server while said load generating unit selects one as said measurement target resource from a plurality of said resources in the order of the rankings given by said ranking unit on the basis of said processing capability index adjusted by said adjusting unit and sequentially generates said load; and
an estimating unit which estimates said processing capability index corresponding to said resource usage which corresponds to said empty capacity of said physical server from said resource usage acquired by said acquiring unit when said determining unit determines that it is within said allowable range.

6. The control device according to claim 4,
wherein said load generating unit performs a process or thread for generating said load as a plurality of processes or threads, and
said estimating unit estimates said processing capability index of said virtual server in a multi-processor environment.

7. The control device according to claim 4,
wherein said resources include a Central Processing Unit (CPU), a memory, a network Input/Output (I/O), and a hard disk drive I/O.

8. The control device according to claim 7,
wherein a dependent resource can be observed when said load is generated except for said resources, and said load for said dependent resource can be adjusted,
with respect to said dependent resource, said virtual server for measuring performance analyzes dependence between said resources, adjusts said processing capability index, generates said load, and estimates said processing capability index of a goal load.

9. A management device comprising:
a presenting unit which presents a processing capability index obtained by an estimating unit in the control device according to any one of claims 4 to 8, said control device making said virtual server for measuring performance sequentially operate, as a verification target, on said physical servers which are a plurality of move destination candidates.

10. The management device according to claim 9, further includes:
a selection unit which selects a move destination physical server on the basis of the processing capability index obtained by the estimating unit in the control device according to any one of claims 4 to 8, when said virtual server for measuring performance is sequentially operated, as said verification target, on said physical servers which are a plurality of said move destination candidates.

11. A computer-readable storage medium embodying instructions executable by a computer for performing:
a procedure for acquiring respective resource usages of a plurality of resources with respect to a physical server and a virtual server which is operated on said physical server;
a procedure for generating a load for a measurement target resource;
a procedure for applying said load to said measurement target resource to acquire resources on which said measurement target resource depends, and calculate dependence numbers of said measurement target resource on the basis of the number of resources on which said measurement target resource depends;
a procedure for ranking a plurality of said resources in descending order of said dependence numbers which is calculated for respective resources as said measurement target resource; and
a procedure for adjusting a processing capability index of said resource usage of said measurement target resource while sequentially selecting one as said measurement target resource from a plurality of said resources in the order of the rankings and sequentially applying said load to the selected measurement target resource.

12. The computer-readable storage medium according to claim 11, further embodying instructions executable by a computer for performing:
a procedure for operating a virtual server for measuring performance including said program on said physical server, which is a move source, instead of at least one virtual server operated on said physical server;
a procedure for generating said load on said physical server, instead of said at least one virtual server operated on said physical server, which is said move source;
a procedure for periodically acquiring said respective resource usages of a plurality of said resources with respect to said physical server and said virtual server for measuring performance operated on said physical server; and
a procedure for adjusting said processing capability index.

13. The computer-readable storage medium according to claim 12,
further embodying instructions executable by a computer for performing:
a procedure for adjusting said processing capability index on the basis of said resource usage of each resource which is acquired in said acquiring procedure such that resource usage obtained by subtracting said resource usage of said measurement target resource, to which said load is currently applied in said load generating procedure, corresponding to any other resource usage of said resources which are other than current measurement target resource and to which said load has been previously applied in said load generating procedure, from a predetermined target resource usage of said measurement target resource of said virtual server, is acquired as said resource usage of current measurement target resource;
a procedure for determining whether said resource usage acquired in said acquiring procedure is within an allowable range of said target resource usage while said load generating procedure selects one as said measurement target resource from a plurality of said resources in the order of the rankings given in said ranking procedure on the basis of said processing capability index adjusted in said adjusting procedure and sequentially generates said load; and
a procedure for estimating said processing capability index corresponding to said target resource usage from said resource usage acquired in said acquiring procedure when it is determined in said determining procedure that it is within said allowable range.

14. The computer-readable storage medium according to claim 12,
further embodying instructions executable by a computer for performing:
a procedure for operating said virtual server for measuring performance on a physical server to be verified;
a procedure for adjusting said processing capability index on the basis of said resource usage of each resource which is acquired in said acquiring procedure such that resource usage obtained by subtracting said resource usage of said measurement target resource, to which said load is currently applied in said load generating procedure, corresponding to any other resource usage of said resources which are other than current measurement target resource and to which said load has been previously applied in said load generating procedure, from a predetermined target resource usage corresponding to empty capacity of said virtual server, is acquired as said resource usage of current measurement target resource, while said load generating procedure selects one as said measurement target resource from a plurality of said resources in the order of the rankings given in said ranking procedure and sequentially generates said load to the selected measurement target resource;
a procedure for determining whether said resource usage acquired in said acquiring procedure is within an allowable range of said resource usage corresponding to said empty capacity of said physical server while said load generating procedure selects one as said measurement target resource from a plurality of said resources in the order of the rankings given in said ranking procedure on the basis of said processing capability index adjusted in said adjusting procedure and sequentially generates said load; and
a procedure for estimating said processing capability index corresponding to said resource usage which corresponds to said empty capacity of said physical server from said resource usage acquired in said acquiring procedure when it is determined in said determining procedure that it is within said allowable range.

15. A data processing method of a control device which measures a load for a plurality of resources with respect to a physical server and a virtual server which is operated on said physical server,
wherein said control device acquires respective resource usages of a plurality of said resources with respect to said physical server and said virtual server which is operated on said physical server,
said control device generates a load for a measurement target resource,
said control device applies said load to said measurement target resource to acquire resources on which said measurement target resource depends, and calculate dependence numbers of said measurement target resource on the basis of the number of resources on which said measurement target resource depends,
said control device ranks a plurality of said resources in descending order of said dependence numbers which is calculated for respective resources as said measurement target resource, and
said control device adjusts a processing capability index of said resource usage of said measurement target resource while sequentially selecting one as said measurement target resource from a plurality of said resources in the order of the rankings and sequentially applying said load to the selected measurement target resource.

16. The data processing method of the control device according to claim 15,
wherein, instead of at least one virtual server operated on said physical server, a virtual server for measuring performance is operated on said physical server, which is a move source, thereby implementing said control device,
said control device generates said load on said physical server, instead of said at least one virtual server operated on said physical server, which is said move source,
said control device periodically acquires said respective resource usages of a plurality of said resources with respect to said physical server and said virtual server for measuring performance operated on said physical server, and
said control device adjusts said processing capability index.

17. The data processing method of the control device according to claim 16,
wherein said control device adjusts said processing capability index on the basis of the acquired resource usage of each resource such that resource usage obtained by subtracting said resource usage of said measurement target resource, to which said load is currently applied, corresponding to any other resource usage of said resources which are other than current measurement target resource and to which said load has been previously applied, from a predetermined target usage of said measurement target resource of said virtual server, is acquired as said resource usage of current measurement target resource,
said control device determines whether said acquired resource usage is within an allowable range of said target resource usage while selecting one as said measurement target resource from a plurality of said resources in the order of the rankings on the basis of the adjusted processing capability index and sequentially generating said load, and
said control device estimates said processing capability index corresponding to said target resource usage from the acquired resource usage when it is determined that it is within said allowable range.

18. The data processing method of the control device according to claim 16,
wherein said virtual server for measuring performance is operated on a physical server to be verified, thereby implementing said control device,
said control device adjusts said processing capability index on the basis of the acquired usage of each resource such that resource usage obtained by subtracting said resource usage of said measurement target resource, to which said load is currently applied, corresponding to any other resource usage of said resources which are other than the current measurement target resource and to which said load has been previously applied as said resource usage of current measurement target resource, from a predetermined target resource usage corresponding to empty capacity of said virtual server, is acquired, while selecting one as said measurement target resource from a plurality of said resources in the order of the rankings and sequentially generating said load to the selected measurement target resource,
said control device determines whether said acquired resource usage is within an allowable range of said resource usage corresponding to said empty capacity of said physical server while selecting one as said measurement target resource from a plurality of said resources in the order of the rankings on the basis of the adjusted processing capability index and sequentially generating said load, and
said control device estimates said processing capability index corresponding to said resource usage which corresponds to said empty capacity of said physical server from the acquired resource usage when it is determined that it is within said allowable range.
